(19) United States
(12) Patent Application Publication
(10) Pub. No.: US 2015/0295807 A1
(43) Pub. Date: Oct. 15, 2015

(54) MANIPULATION OF STREAMS OF MONITORING DATA

(71) Applicant: Telefonaktiebolaget L M Ericsson (publ), Stockholm (SE)

(72) Inventors: Yangcheng Huang, Athlone (IE); Jan Groenendijk, Athlone (IE)

(73) Assignee: Telefonaktiebolaget L M Ericsson (publ), Stockholm (SE)

(21) Appl. No.: 14/418,420

(22) PCT Filed: Aug. 2, 2012
(86) PCT No.: PCT/EP2012/065111

§ 371 Date: May 28, 2015

(51) Int. Cl. H04L 12/26; G06F 17/30

(52) U.S. Cl. CPC H04L 43/10; G06F 17/30946

(57) ABSTRACT

Streams of monitoring data relating to part of a communications network, are manipulated automatically by looking up a corresponding indexed value in a stored index, and selectively replacing that attribute value with the corresponding indexed value. The selective replacement is based on a characteristic of the stream of monitored data, or the network being monitored. The selection or the indexed values can be adapted dynamically. Such selective replacement at the attribute field level can enable the data to be enriched with embedded information or be compressed more efficiently with less processing overhead by exploiting knowledge of the data format and the network configuration. It is compatible with hardware implementations. The embedded information can enable subsequent processing of the monitored data to be speeded up.

### FIELD

The present invention relates to methods of monitoring parts of a communications network including manipulating a stream of monitoring data using a stored index, to methods of adapting the manipulation, and to corresponding apparatus for manipulating and apparatus for adapting the manipulation and programs for such methods.

### BACKGROUND

Monitoring of network and service performance in large-scale operational networks is becoming increasingly important, especially with the fast deployment of mobile broadband networks and services. Operators need to be able to respond quickly to customer complaints, and be pro-active by continuously monitoring in (near) real time and respond to service affecting changes in network behavior.

(Near) real time monitoring means there is some time between an event recorded by the network until the relevant information from that event is presented as information to the operator.

Continuously monitoring means all relevant events (e.g. subscriber activities) are continuously generated in the network and either logged/collected in files and sent to an OSS or directly streamed to the OSS.

Existing solutions include real-time event stream processing involving classifying and aggregating events (and calculating Key Performance Indicators KPIs for networks and services) based on attribute values.

Attribute values of an event are set based on attributes of the corresponding signaling procedure. An example of an attribute field is a cell ID, which can have various defined values. In order to carry out complex event processing, such as KPI calculation on cell groups or clustering based analysis, the event processing engine has to correlate events in real time with additional data source (such as cell group definitions or topological information of cells). This poses significant overhead on CPU and disk/DB I/O in the presence of high volumes of event streams.

One practice in redundancy elimination in event streaming is to transmit those duplicate values (such as UE information and PDN session information such as APN) only in the starting event record of the stream, and only transmit the key ID such as IMSI and PDN ID (and bearer ID if necessary) in the consequent events.

Another known method of reducing data transmission overhead is to apply data compression methods onto streams, i.e. compressing data sent over a socket. Generally, data compression involves encoding information using fewer bits than the original representation. Compression can be either lossy or lossless. Lossy compression reduces bits by identifying marginally important information and removing it. In contrast, loss less compression exploits statistical redundancy and represents data more concisely without losing information.

In particular, lossless compression exploits redundancy by finding patterns of bits or bytes inside the data block to be compressed. Without priori knowledge of the nature of the data, the pattern can only be detected in finite blocks of data. Some most popular lossless compression methods are the Lempel-Ziv (LZ) method, DEFLATE (a variation on LZ, used in PKZIP, gzip and PNG) and LZW (Lempel-Ziv-Welch, used in GIF images).

In the case of event streams, where communication is continuous and openended (unlike transactional communication with bounded operations “opentransmission-close”), compression can be applied by writing (one or multiple) events into a buffer, compressing previously buffered events and transmitting it without closing the underlying stream.

Redundancy elimination (RE) is used to replace and transmit duplicate information with labels, which brings the following benefits; reduced bandwidth usage cost; reduced network congestion at access links; higher throughputs; and reduction in transfer completion times.

In particular, existing solutions in redundancy identification involve caching data blocks that have been previously seen, including:
Object-level caching, i.e. application layer approaches like Web proxy caches, which stores static objects in local cache. Example solutions are summary cache (Sigcomm 98) and co-operative caching (SOSP 99).
Packet-level caching like the approach proposed by Spring et. al: SIGCOMM 00. Example solutions: WAN Optimization Products like Riverbed, Peribit and Packeteer.
Chunk-level caching, like the protocol-independent redundancy elimination solution described below.

The basic principle of the Protocol-independent RE approach is to identify repeating patterns in the outgoing raw data traffic (bit/byte level) and replace them with labels, so that the original raw data could be reconstructed on the receiver side.

The outgoing data is split into sub-strings (also referred to as chunks) and the redundancy is detected by looking for repeating chunks. The major processing stages are as follows.

Fingerprinting Data.

The goal of this operation is to facilitate identification of repeating patterns in data stream. Rabin fingerprints is the common approach used. The algorithm calculates fingerprint over a sliding window of data. The byte at which special fingerprint is found becomes the last byte of a current data chunk. The result of a fingerprinting is a set of fingerprints and corresponding byte positions.

Indexing and Lookup.

The goal of a lookup is to use fingerprints from a previous step to search for repeating data in the local cache. If the data has been seen earlier and was saved to the cache, the cache must contain corresponding fingerprints. Finding them means that redundancy is detected.

Storing Data.

Data chunks have to be saved in the cache for the purpose of repetition detection. RE systems tend to increase redundancy elimination ratio by increasing storage capacity, thus eventually the data has to be stored on hard drive.

Assuming that the system is completely protocol unaware (i.e. cannot tell, in general, whether given piece of data is unique or highly repetitive), the decision can be based on whether data is new or it is already present in the cache. On one hand, saving all data to the cache consumes more storage space; on the other hand, it improves data access locality and may improve compression.

Reconstructing Data.

The task of data reconstruction is to restore the original data from the compressed one. The approach has two major advantages. First, it is protocol-independent. Because the method is applied to raw data, there is no need to know which protocol is used for the particular data transfer; the redundancies are identified across the whole protocol stack. Second, the mechanism tolerates modifications of the original objects. If some data object, such as a file, is partially modified before it is transferred for the second time, those parts of it which remain unchanged will still benefit from the optimization.

An implementation of a middle-box based approach is as follows: An RE implementation requires the installation of two middleware boxes; one closer to the server (encoder) and one closer to the client (decoder). As data flows from the server to the client, it passes through the boxes and is broken into chunks. The chunks are stored on the persistent storage of each box. For each chunk, a representing fingerprint (hash) that maps to the actual chunk is generated and stored in the memory (e.g. a 1 KB stream can be represented by a collision-free 20B hash). The two boxes communicate through an out-of-band TCP connection such that the data are delivered in order. Since both boxes contain the same data, they are synchronized. A second reference to a chunk would mean that the encoding box would send the hash value instead of the actual bytes.

### SUMMARY

According to an aspect of the present invention, there is provided a method of monitoring a part of a communications network, having the steps of: receiving a stream of monitoring data relating to the part of the network, the stream of monitoring data having a repeating data format of attribute fields, and manipulating the stream of monitoring data automatically by: detecting the attribute fields in the stream of monitoring data, and for an attribute value of selected attribute fields, looking up a corresponding indexed value in a stored index, and selectively replacing that attribute value in the data stream with a corresponding indexed value, wherein the selective replacement is based on a characteristic of at least one of: the stream of monitored data, and the network being monitored.

A benefit of such selective replacement at the attribute field level is that the monitoring data can be enriched or compressed more efficiently with less processing overhead by exploiting knowledge of the data format and the network configuration, which cannot be achieved by other lower level compression techniques. Also it is compatible with hardware implementations for faster processing. Furthermore, since the replacement is carried out at the attribute field level rather than a bit level, and because the values are indexed, they are consistent and predictable and so some data processing operations on the attribute values, such as scaling, can be carried out instead on the mapping. Thus repetition of the same operation on multiple instances of the same attribute value can be avoided and thus the processing resource required can be reduced. See FIG. 2 or FIG. 13 for example.

Any additional features can be added to these features, and some such additional features are set out below and set out in dependent claims and described in more detail. One such additional feature is the characteristic being redundancy in the stream of monitored data and the selective replacement is based on at least how many unique attribute values there are for the respective attribute field, and on frequencies of occurrence of the different attribute values. This can help to limit the amount of replacement to those where there is most redundancy for example. This means that fewer indexed values may be needed, and so they can be shorter, thus improving compression efficiency. Also it can mean that fewer replacements are needed for a given reduction in redundancy, thus reducing the processing resource needed to make the replacements. See FIG. 3 for example.

Another such additional feature is the step of replacing at least one of the attribute values comprising replacing it with a corresponding indexed value comprising embedded information concerning the part of the network which is generating the monitoring data. This can enable some types of processing of the indexed values to take into account such embedded information without needing to carry out additional steps of looking up such information from an external source for each of the indexed values. Thus such processing can be carried out much more efficiently or quickly. See FIG. 5 for example.

Another such additional feature is the embedded information concerning the part of the network comprising information about relationships between the part and other parts of the network. Such information about relationships can enable correlation with data from monitoring such other parts to be carried out more efficiently for example. See FIG. 5 for example.

Another such additional feature is the step of processing the monitoring data using the indexed values. This can help avoid the need to reconvert the indexed values back to the original attribute values and thus reduce processing resource requirements. As the indexed values can be shorter, this can also help reduce the processing resource requirement. See FIGS. 4, 5 and 6 or 15 or 17 for example.

Another such additional feature is the processing step comprising correlating monitored data from related parts of the network using the embedded information about relationships between the part and other parts of the network. Such correlation is a particularly useful type of processing, for example to locate causes of faults. Notably this can be carried out much more efficiently or more quickly by using information about relationships in the indexed values since there is less time and resource spent looking up the relationship information from elsewhere. See FIG. 6 for example.

Another such additional feature is the step of dynamically adapting how the stream of monitoring data is manipulated in use by altering any of: the selection of attribute field, the selection of attribute values to be replaced, and the corresponding indexed values in the stored index. This can enable adaptation to changing conditions such as changes of value occurrence frequencies, over different time periods, or over multiple networks, or changes in how the monitored data is to be processed, for example from group based analysis (pre-defined cell groups) to cluster analysis based on cell geographical distributions (to identify areas with weak wireless signals in a mobile network example).

Another such additional feature is the step of observing frequencies of occurrence of the different attribute values in use and adapting the selection of attribute values to be replaced, based on the observed frequencies. This can help to improve the efficiency of compression, and adapt it to changing conditions. See FIG. 9 or 16 or 18 for example.

Another such additional feature is the step of replacing the attribute values comprising replacing variable length attribute values with corresponding indexed values having a fixed length. This can make processing of such index values faster, and can help enable processing hardware to be optimized for such fixed lengths. See FIG. 11 for example.

Another such additional feature is the step of maintaining a database at the network management system and storing the received monitoring data in the database after the step of replacing at least one of the attribute values, without reconverting the indexed values back to the corresponding attribute values. This can help reduce processing and storage resource requirements. The index can be stored also to help enable later reconversion. See FIG. 12 for example.

Another aspect provides a method of adapting manipulation by apparatus having a stored index, of a stream of monitoring data relating to a part of a communications network, the stream of monitoring data having a repeating data format of attribute fields, the manipulating involving replacing selected attribute values with indexed values, the stored index having a mapping of indexed values corresponding to attribute values to be replaced. The adapting involves generating selection information about which of the attribute fields and which of their values are for replacement, and generating corresponding indexed values, based on a characteristic of at least one of: the stream of monitored data, and the network being monitored. The selection information and the corresponding indexed values are sent to the apparatus to cause it to adapt its manipulation of the monitoring data according to the selection information and corresponding indexed values. By adapting such manipulating apparatus it can become more efficient for the conditions including the network configuration. See FIGS. 7, 8, 13 or FIG. 16 for example.

Another such additional feature is, for each of the attribute fields, identifying how many unique attribute values there are for the respective attribute field, and identifying frequencies of occurrence of the different attribute values, and deriving a characteristic of the stream of monitoring data comprising amounts of redundancy for different ones of the attribute fields, based on the numbers of unique attribute values, and how frequently the different attribute values occur and generating the selection information based on these redundancy characteristics. See FIG. 9 for example.

Another such additional feature is the step of identifying how many unique attribute values there are for the respective attribute field having a step of deriving this from at least one of: configuration information about the network, and observations of monitoring data over a period of time in use. For some types of attribute field this provides limitations which enable the number of values to be deduced. See FIG. 9 for example.

Another such additional feature is the step of identifying a frequency of occurrence comprises the step of observing frequencies of occurrence of the different attribute values in use over a period of time. This can help to improve the efficiency of compression, and adapt it to changing conditions. See FIG. 9 and FIG. 16 for example.

Another such additional feature is the step of selecting an indexed value to have embedded information concerning the part of the network which is generating the monitoring data. By including such information in the indexed values this can enable some types of processing of the indexed values to take into account such information without needing to carry out additional steps of looking up such information for each of the indexed values. Thus such processing can be carried out much more efficiently or quickly. See FIG. 9 or 16 for example.

Another such additional feature is the embedded information concerning the part of the network comprising information about relationships between the part and other parts of the network. By including such information about relationships in the indexed values, this can enable correlation with data from monitoring such other parts to be carried out more efficiently for example. See FIG. 10 or 16 for example.

Another aspect provides apparatus configured to carry out methods as set out above. Another aspect provides apparatus for manipulating a stream of monitoring data relating to a part of a communications network, the stream of monitoring data having a repeating data format of attribute fields, the apparatus having a stored index having a mapping of indexed values corresponding to the selected attribute values to be replaced, characteristic of at least one of: the stream of monitored data, and the network being monitored. The apparatus also has look up circuitry, configured to detect the attribute fields in the stream of monitoring data, and for selected attribute fields, to use the attribute values to look up corresponding indexed values in the stored index. Replacing circuitry is provided configured to selectively replace the attribute values in the data stream with corresponding indexed values according to the stored index.

Another such additional feature is a monitoring data processor configured to carry out real time processing on the monitoring data having the indexed values. See FIG. 4 for example.

Another such additional feature is adaptation apparatus coupled to any of the stored index, the look up circuitry and the replacing circuitry for dynamically altering the manipulating in use by altering any of: the selection of attribute field, the selection of attribute values to be replaced, and the corresponding indexed values in the stored index.

Another such additional feature is the indexing adaptation circuitry having a selector configured to determine amounts of redundancy in attribute fields, and an indexing part configured to selectively create the indexed values for the mapping in the index. See FIG. 4 for example.

Another aspect provides adaptation apparatus for adaptation of a manipulating operation by apparatus having a stored index, to manipulate a stream of monitoring data relating to a part of a communications network, the stream of monitoring data having a repeating data format of attribute fields, the manipulating involving replacing selected attribute values with indexed values, the stored index having a mapping of indexed values corresponding to attribute values to be replaced. The apparatus has a processor and memory configured to generate selection information about which of the attribute fields and which of their values are for replacement, and to generate corresponding indexed values, based on a characteristic of at least one of: the stream of monitored data, and the network being monitored. An interface is provided for sending the selection information and the corresponding indexed values to the adaptation apparatus to cause it to adapt its manipulation of the monitoring data according to the selection information and corresponding indexed values. Such adaptation can enable the manipulation to become more efficient to match changing conditions or match the network configuration for example. It can enable the index and the selection to be built up and maintained automatically in some cases. This adaptation part can be located centrally to help enable the network management system to control the manipulation more easily than if it were distributed around the network. If the look up part and the replacing part are located remotely, the benefit of the compression is present in the transmission of the monitoring data, as well as assisting with aggregation, processing and storing of the monitoring data at the network management system. See FIG. 13 for example.

Another aspect provides a computer program having instructions on a non transient computer readable medium which when executed by a processor, cause the processor to carry out any of the methods above, involving manipulating the monitoring data using the index, or adapting the operation of manipulating.

Any of the additional features can be combined together and combined with any of the aspects. Other effects and consequences will be apparent to those skilled in the art, especially over compared to other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

Embodiments of the invention will be described, by way of example only, with reference to the accompanying drawings in which:

FIG. 1 shows a schematic view of apparatus according to a first embodiment,

FIG. 2 shows steps of a method of monitoring with selective replacement according to an embodiment,

FIG. 3 shows steps including selective replacement based on redundancy

FIG. 4 shows apparatus including a data processor for processing the monitoring data after the selective replacement,

FIGS. 5 and 6 show embodiments with selective replacement including embedded information,

FIG. 7 shows a schematic view of adaptation apparatus for adapting the manipulating according to an embodiment,

FIGS. 8 9 and 10, show methods of adapting the selective replacement according to embodiments,

FIGS. 11 and 12 show further embodiments with selective replacement and further features,

FIG. 13 shows an embodiment having apparatus for manipulating the monitored data and for adapting the manipulating,

FIG. 14, shows an O and M network example for transmitting event data,

FIG. 15 shows an event based embodiment,

FIG. 16, shows an embodiment for building an index,

FIG. 17 shows an embodiment for real time processing,

FIG. 18 shows a method with compression and adaptation of indices according to an embodiment,

FIG. 19 shows an embodiment with real time processing, and

FIG. 20 shows an embodiment with compression and index build functions.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes.

### ABBREVIATIONS

### APN Access Point Name

### ASN.1 Abstract Syntax Notation One

### BER Basic Encoding Rules

### BGW Border GateWay

### CEP Complex Event Processing

### CAM Content Addressable Memory

### CPG Converged Packet Gateway

### CPU Central Processing Unit

### DPI Deep Packet Inspection

### EBM Enterprise Business Messages

### EPG Evolved Packet Gateway

### GGSN Gateway GPRS Support Node

### GPRS General Packet Radio Service

### IMEI International Mobile Equipment Identity

### IMSI International Mobile Subscriber Identity

### KPI Key Performance Indicator

### MME Mobility Management Entity

### NMS Network Management System

### O&M Operations and Maintenance

### OSS Operational Support System

### PDN Packet Data Network

### PER Packed Encoding Rules

### RAN Radio Access Network

### RE Redundancy Elimination

### ROP Relationship Oriented Programming

### SGSN Serving GPRS Support Node

### TCAM Ternary CAM

### TCP Transmission Control Protocol

### UE User Equipment

### URI Uniform Resource Identifier

### WAN Wide Area Network

### XER XML Encoding Rules

XML extensible Markup Language

### 3GPP 3rd Generation Partnership Project

### DEFINITIONS

Where the term “comprising” is used in the present description and claims, it does not exclude other elements or steps and should not be interpreted as being restricted to the means listed thereafter. Where an indefinite or definite article is used when referring to a singular noun e.g. “a” or “an”, “the”, this includes a plural of that noun unless something else is specifically stated.

Elements or parts of the described nodes or networks may comprise logic encoded in media for performing any kind of information processing. Logic may comprise software encoded in a disk or other computer-readable medium and/or instructions encoded in an application specific integrated circuit (ASIC), field programmable gate array (FPGA), or other processor or hardware.

References to nodes can encompass any kind of switching node, not limited to the types described, not limited to any level of integration, or size or bandwidth or bit rate and so on.

References to programs or software can encompass any type of programs in any language executable directly or indirectly on processing hardware.

References to processors, hardware, processing hardware or circuitry can encompass any kind of logic or analog circuitry, integrated to any degree, and not limited to general purpose processors, digital signal processors, ASICs, FPGAs, discrete components or logic and so on. References to a processor are intended to encompass implementations using multiple processors which may be integrated together, or co-located in the same node or distributed at different locations for example.

The functionality of circuits or circuitry described herein can be implemented in hardware, software executed by a processing apparatus, or by a combination of hardware and software. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to perform the required functions. Embodiments can have programs in the form of machine-readable instructions (software) which, when executed by a processor, perform any of the described methods. The programs may be stored on an electronic memory device, hard disk, optical disk or other machine-readable storage medium or non-transitory medium. The programs can be downloaded to the storage medium via a network connection.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

### INTRODUCTION

By way of introduction to features of embodiments of the invention, some discussion of known features will be presented.

### Events and Event Based Monitoring

Events and event based monitoring will be described, as an example of one type of stream of monitoring data, though many embodiments are not limited to such events. An event is an object that is a record of an activity in a system. This concept is different from the everyday usage of “event” as “something that happens”', since the event here is an object signifying an activity; in event processing, event objects are processed, not, not activities. Also, an event is not just a message. Generating a message is a common way of generating an event. However, an event also contains data describing the activity it signifies (such as results of a signalling procedure); due to the relations (such as time and causality) between activities, events have the same relationships to one another as the activities. In particular, events from a mobile radio system are defined as follows: An object or signal carrying information about any discernable occurrence that has significance for the management of the mobile radio infrastructure or the delivery of service and evaluation of the impact a deviation might cause to the services.

A mobile radio system consists of user equipments (for example mobile phones or laptop's modems), radio access networks and core networks. Events are defined in such systems to monitor network and service performance and manage subscriber service experiences.

A mobility or session management message (for example, Create Session Request message) used in a signaling procedure (for example, Initial Attach procedure) triggers an event (for example, SESSION_CREATION event). Refer to 3GPP TS 23.401 for more information about mobility and session message procedures and messages.

The sGW nodes set an event outcome, together with detailed contextual information about the signaling procedure (timestamps, PDN information, UE information, and bearer statistics), into a data block using pre-defined structures. The events may be encoded in bit-packed binary format based on a XML file (that defines its format). Events are then transmitted to an external post-processing system (such as EBM application) that decodes the events in files every ROP (for example lasting for periods of 15 minutes) or streamed to a specified IP address.

Event based applications collect generated events, either in (compressed) ROP files or in real-time streams, and process events, including:
Showing important statistical indicators of the network performance in real time;
Providing accurate insights into the subscriber experiences, i.e. understanding how subscribers perceive the quality of the service being provided; and
Providing means for detailed trouble shooting of the network and services.

For these purposes, event parameters such as failure codes and sub failure codes are defined to help troubleshooting the network. Such O&M information is unique to events of mobile radio networks and useful in the context of (root) cause analysis of network problems.

Unless specially specified, the event concept in this document refers to O&M events, e.g. objects carrying information about O&M occurrences.

Compared to other monitoring methodologies, event based monitoring has the following advantages:
(1) Events provide thorough observability into networks and services. Events carry detailed contextual information of the occurrence, including when, where, how, what and why, and
(2) Compared to counter based approach, events can be propagated to network management systems in real time, which facilitates real-time monitoring with reduced latency.

These advantages of event based monitoring are at the cost of extra overhead in transmission and processing. Contextual information dramatically increases the size of an event, while real-time transmission and processing of events poses stringent requirements on the capacity of both networks and systems.

### Characteristics of Event Stream Traffic

Compared to messages or events for general purposes (such as twitter messages), event stream traffic has the following characteristics. Aggregate traffic; thousands (or even tens of thousands of) simultaneous streams originated from nodes are sent towards one O&M server; for example, a least one operational network in use now has up to 50,000 event streams; Constant event streams; event data is pushed from nodes constantly; event streams (such as events describing status of subscriber mobility management and session management; refer to 3GPP TS 23.401, TS 29.274, TS 36.401) are long-lasting and persistent in a production/operational network, as long as One-way data transmission; event data is pushed from nodes towards the NMS only;

Low event/data rate per stream but potentially very high after aggregation; event/data rate per stream is low, typically 10 k-100 k bps; however, aggregated event/data rate can be as high as Gigabit bps, which poses significant challenges in event processing and forwarding;

Well structured events, but with diverse event format; event streams may come from multiple data sources (RAN/Core/Transport); event formats and encoding vary over node types (with different technologies/domains), node versions and node vendors; a large number of encoding formats are used in practice, such as Google protocol buffer, ASN.1 (BER/XER/PER) or XML. The data may be bit-packed, byte-packed, or even in XML format or ASCII format; even the same types of events may have different definitions (such as bearer session traffic statistics from Cisco BGW nodes as compared to those from CPG/sGW nodes) in terms of attribute definitions.

Spatially varied stream characteristics; event streams from different networks, of different node types and node locations, may have significantly different event rates;

Time varied stream characteristics; even from the same network, event rate may vary significantly over different time periods; busy hour (BH) event rate is expected to be higher than average event rate, while event rate during peak time periods can be three times higher than busy hour event rate.

### Redundancy in Event Streams

Attributes of an event can have contextual details about a signaling procedure or measurement, including for example IP addresses of participating nodes, PDN information and UE information (IMSIs etc). Event stream traffic exhibits large amount of redundancy. Duplicate values of event attributes appear frequently across events of the same stream, or multiple streams. Such redundancy is caused by the following reasons:

### (1) Definitions of Attributes:

Event attribute is usually defined to be 3GPP compliant (refer to 3GPP TS 23.003). The size/length of each attribute is defined to be capable of accommodating the maximum number of unique values. For example, an IP address attribute is defined as a 4-byte array, an APN as 100 octets, and an URI as 800 bits. The data type of each attribute is defined based on the nature of the attribute. For example, APNs and URis are octet strings.

(2) Locality of Attribute Values with Restricted Value Space:

O&M events are different from other events (such as events from financial markets). In a real-world scenario, possible unique values of an attribute are limited by local configurations. The value space of some attributes is quite restricted.

For example, a typical (large) operational network may configure 1000 APNs, with 40 EPG nodes (which corresponds to 40 pGW IP addresses). Signaling procedures are associated with these nodes and identifiers. Because of this, the same values of an attribute may be frequently accessed. The same values may appear frequently in the same stream or multiple streams, either with events of the same type or with events of different types.

In particular, there are two basic types of locality: temporal locality and spatial locality. Temporal locality refers to re-occurrence of specific attribute values within relatively small time periods (for example, busy hours within a day or URLs associated with sudden events). Spatial locality refers to re-occurrence of specific attribute values within relatively close locations.

### (3) Distributions of Attribute Values:

Not all of the attribute values appear with the same frequency or probability. It suggests that the frequency of (at least some of) the attribute values follows zip-f distribution, i.e. the popularity of an attribute value is inversely proportional to its rank in the frequency table. A few values appear extremely frequent, a medium number of values with moderate frequency, while a huge number of values relatively inactive. Due to their frequent occurrence, these popular attribute values contribute to data redundancy in event streams.

Problems with Real-Time Event Stream Processing

Existing event stream processing solutions (such as group based analysis or clustering based analysis) require correlating event streams with topological information in real time. Considering the high event rate, such lookup/correlation operations would significantly increase overhead on CPU and disk/DB I/O, which slows the performance of the whole system.

Problems with Redundancy Elimination Solutions

Transmitting Once-for-all as mentioned above has problems as follows. Transmitting duplicate values in starting records and identifiers only in the consequent records reduces transmission overhead. However, in order to process the events (such as APN based aggregations), the consequent events have to be enriched with the missing information in order to carry out the proposed aggregation, no matter it is online processing or offline processing. A list of live session information would have to be maintained, so that the missing values can be looked up.

Another drawback of this solution is that it only applies to a single event stream and cannot remove redundancy across multiple event streams.

### Data Compression

Data compression can only reduce redundancy inside the data block to be transmitted. It cannot handle redundancy across multiple event blocks, or across multiple event streams.

### Redundancy Elimination (RE)

As mentioned earlier, RE solutions identify redundancy by caching information (objects, packets or chunks) that has been previously seen. The major problem of applying such redundancy elimination to event based realtime monitoring is its cost on storage and processing. Protocol-independent RE detects redundancies based on repetition of byte or bit level data blocks. Effective protocol-independent RE requires looking for small redundant chunks of the order of 32-64 bytes (because most transfers involve just a few packets each). The standard algorithms for such fine scale redundancy are very expensive in memory (i.e. caching of data that have been seen) and processing especially for continuous event streams originated from nodes like MMEs or CPGs, potentially with very high event rates.

In particular,

(1) A large storage is not feasible or cost-effective for a network node.
(2) Processing overhead in redundancy identification may have a major impact on node performance.
(3) On the receiver side, event data has to be reconstructed before any further processing. This would introduce high processing overhead for network management applications, considering the volume of aggregate event traffic.
(4) It introduces additional equipment for each connection to support RE function.

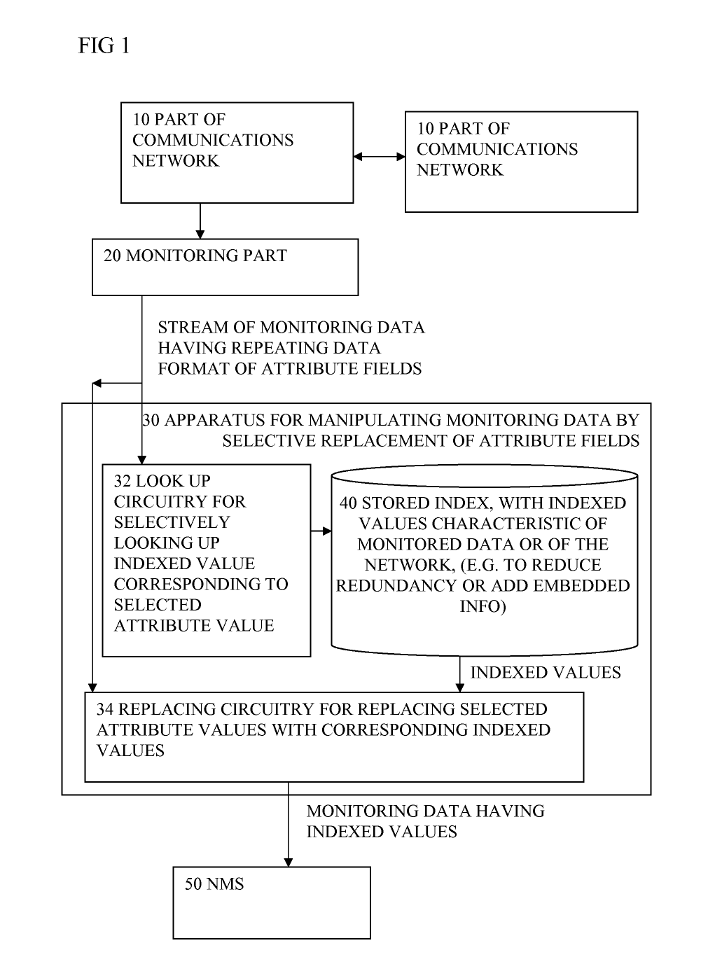

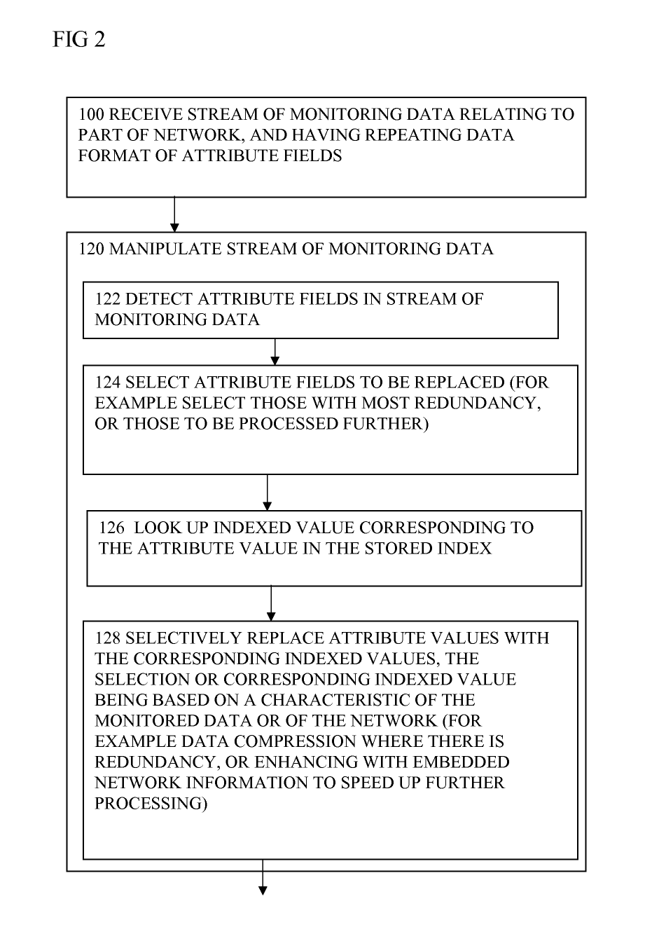

### FIGS. 1 and 2, a First Embodiment

FIG. 1 shows a schematic view of a first embodiment. A monitoring part 20 is provided for generating a stream of monitoring data about part of a communications network. Two parts 10 of the network are shown, there can be many more. The monitoring part may be incorporated with the part or can be separate. The stream of monitoring data has a repeating data format of attribute fields and is fed to a network management system NMS 50 via apparatus 30 for manipulating the monitoring data by selective replacement of attribute fields. This may be incorporated with the part of the network being monitored, or may be incorporated with the NMS, or may be anywhere in between in principle. The data compressing part has look up circuitry 32 coupled to a stored index 40, for selectively looking up an indexed value in the stored index corresponding to selected attribute vale of a selected attribute field. The index can be implemented as a look up table or in principle can be implemented in other ways to achieve a similar function, for example as circuitry or a processor for carrying out an algorithm to obtain the indexed values. Replacing circuitry 34 is provided coupled to receive the stream of monitoring data and the indexed values and is configured to replace the selected attribute values with corresponding indexed values. The stored index has a mapping of unique indexed values corresponding to the selected attribute values to be replaced, such that the selection of attribute fields for replacement, and the selection of attribute values to be replaced is based on a characteristic of the monitored data or of the network being monitored. This replacement at the attribute field level can be for compression or for enhancement of the monitored data, or both, as will be explained below.

FIG. 2 shows steps of a method of monitoring a part of a communications network, for use in the network of FIG. 1 or in other embodiments. There is a step 100 of receiving the stream of monitoring data relating to a part of the network, the stream of monitoring data having a repeating data format of attribute fields. At step 120 the stream of monitoring data is manipulated by selective replacement of attribute fields. This involves a step 122 of detecting the attribute fields in the stream of monitoring data, and at step 124 selecting the attribute fields to be replaced, for example those with most redundancy or those which are to be processed further and which can therefore benefit from enhancement to ease that further processing. This selection step can be implemented in various ways in principle. For example it can be inherent in or built into the stored index, by replacing all of the fields or values but having some of the indexed values being unchanged and some (the “selected” ones) being new values. Alternatively the selection can be implemented by looking up all of the fields or values but only replacing some. Alternatively only some of the fields or values are looked up and replaced.

At step 126 there is a look up step to provide an indexed value in the stored index corresponding to an attribute value of an attribute field. This can be implemented in various ways, for example a conventional addressable memory, or a content addressable memory or other circuitry. At step 128 that attribute value in the data stream is replaced with a corresponding indexed value according to the stored index. This selective replacement at the attribute field level is based on a characteristic of the monitored data or of the network, and can be for various purposes for example to reduce redundancy in the monitored data or to enhance it with embedded information to speed up further processing.

Note that existing redundancy reduction solutions including data compression and RE solutions, work at a different layer compared to the proposed embodiments. Hence the proposed embodiments can be deployed in combination with existing redundancy reduction solutions.

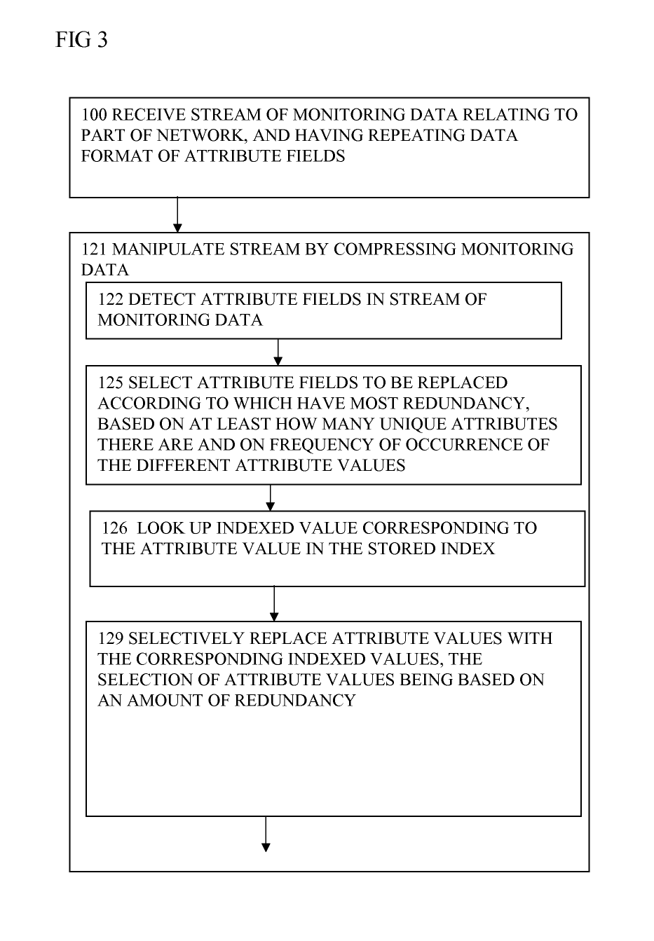

FIG. 3 shows steps according to another embodiment, with features for data compression. Step 121 of manipulating the stream by compressing the monitoring data to reduce redundancy is provided instead of step 120. It is implemented by steps 122, 125, 126 and 129 as follows. At step 122 there is a step of detecting attribute fields in the stream. At step 125, the selection of which attribute fields are to be replaced is made according to which have more redundancy. This can be found based on how many unique attribute values there are for the respective attribute field, and frequencies of occurrence of the different attribute values. This can enable the monitoring stream to be compressed more efficiently.

Step 126 shows looking up the indexed value corresponding to the attribute value in the stored index. At step 129, there is a step of selectively replacing the attribute values with the corresponding indexed values. In some cases this can involve replacing only some of the attribute values of the selected attribute field, such selection again being based on an amount of redundancy.

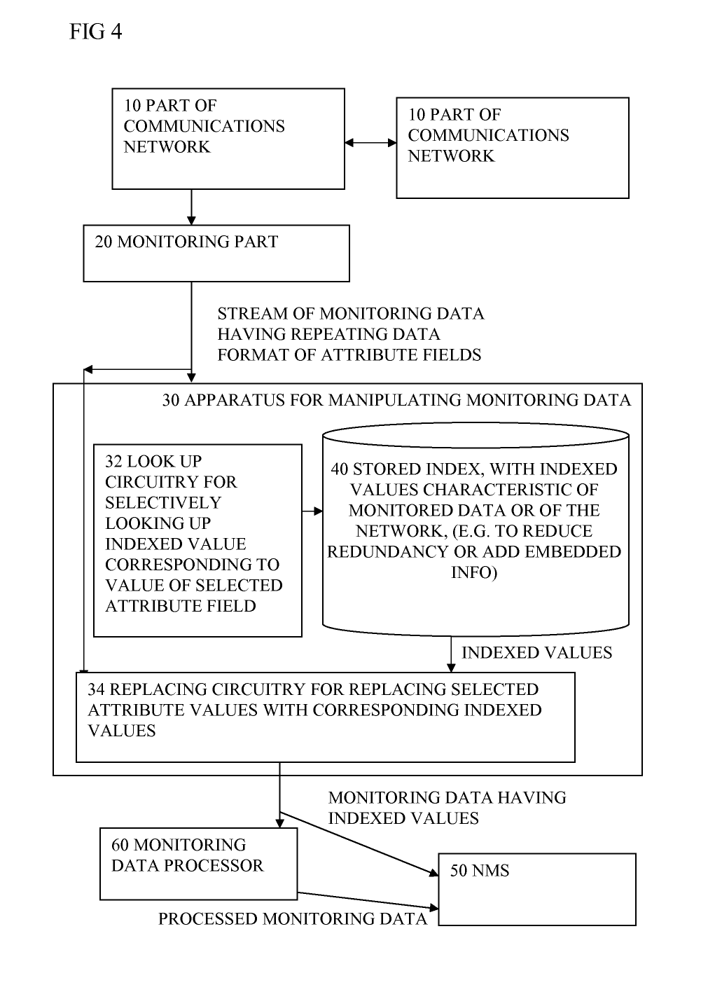

FIGS. 4, 5, 6, Embodiments with Embedded Information for Further Processing

FIG. 4 shows an arrangement similar to that of FIG. 1, with the addition of a monitoring data processor 60 able to process the monitored data having the indexed values, without needing to reconvert the indexed values back to their original attribute values. In some cases this data processor can be arranged to exploit embedded information in the indexed values in the monitored stream, in other cases it can carry out some operations once by processing the index rather than carrying out the same operation on the indexed values repetitively.

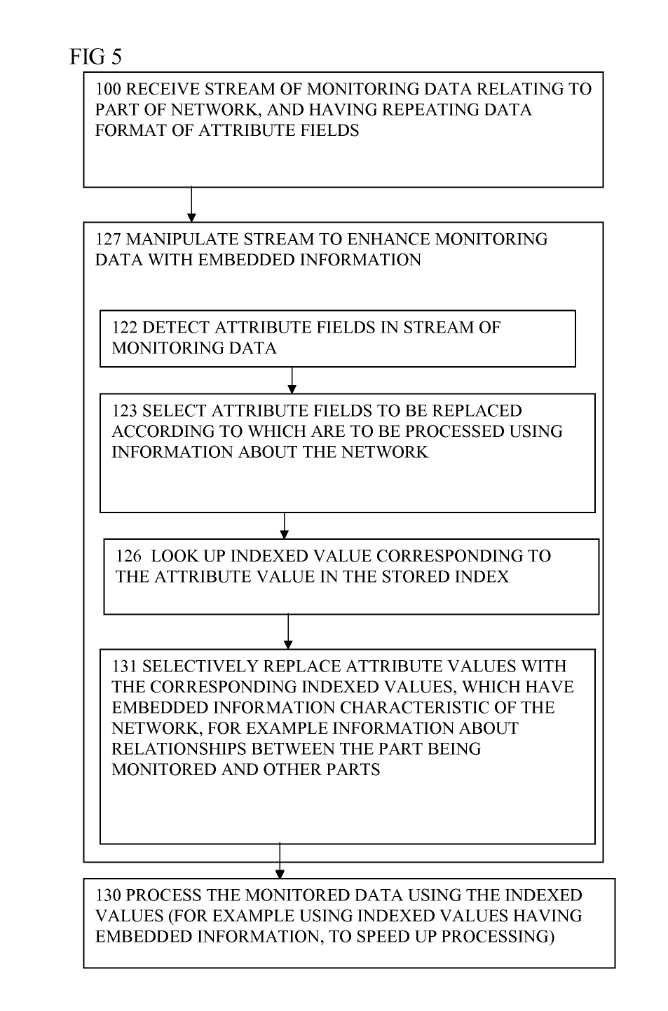

FIG. 5 shows operational steps according to an embodiment using the network of FIG. 4 or other networks. Some steps are similar to those of FIG. 2, and the same reference signs have been used where appropriate. Step 127 of manipulating the stream of monitoring data to enhance it with embedded information, is provided instead of step 120. It is implemented by steps 122, 123, 126 and 131 as follows. At step 122 there is a step of detecting attribute fields in the stream. At step 123, the selection of which attribute fields are to be replaced is made according to which of the fields are to be processed using information about the network.

Step 126 shows looking up the indexed value corresponding to the attribute value in the stored index. At step 131, there is a step of selectively replacing the attribute values with the corresponding indexed values which have embedded information characteristic of the network, for example information about relationships between the part being monitored and other parts of the network. This can be useful in enabling easier or more rapid processing of the monitoring data. In particular examples the information is about relationships with other parts such as which nodes are neighbouring or in the same cluster, or on the same path for example. This can enable correlation of monitoring data from different parts or averaging or comparing monitoring data from related parts of the network, with less need for additional resources to look up such information.

At step 130 there is a step of processing the monitoring data with indexed values, for example those having the embedded information. This can help enable the monitoring data processor to carry out processing of the monitoring data while it has indexed values, which can be more efficient than equivalent processing before the replacement step.

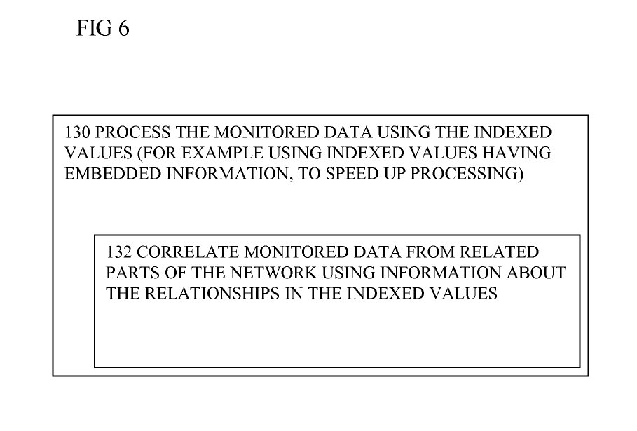

FIG. 6 shows an embodiment having steps similar to those of FIG. 5, in which the step 130 of processing the monitored data using the indexed values is implemented by a step of correlating monitored data from related parts of the network using information about the relationships in the indexed values. As before, by having such information in the indexed values, processing of the monitoring data can be made more efficient. It can be real time processing or off-line processing based on stored monitoring data.

The embodiments of FIGS. 1 to 6 can be combined to provide compression and added embedded information. The monitoring stream can be event based. In a typical event based real-time monitoring scheme, nodes of a large-scale operational network send event traces over TCP/IP connections towards network management applications.

Stream collection/termination functions bind to pre-defined ports and await event streams to arrive. This embodiment enables an enhanced event based real-time monitoring solution by (1) analyzing redundancy of event attributes and identifying redundancies, (2) selectively building indices for attribute fields of an event with topological relations, and (3) processing events in real-time based on the indices inside the events.

In at least some embodiments, attribute fields of an event are analyzed in terms of field size, number of unique values, frequency of each field value; redundancy is identified as a result. Indices are built upon the selected redundant values of an attribute field, with topological relations between indexed items (such as cell groups). Values of attribute fields of an event are replaced with the built indices before the event is transmitted to a network management application. The events can be processed in real-time (instead of original values) using information about the part of the network, such as for example topological knowledge, embedded in the indices.

Compared to known replacement of repetitive data with labels or signatures, the embodiments described can provide selective replacement using a stored index based on knowledge (including event format definition and domain knowledge such as topologies) of the data (i.e. events) for the purpose of redundancy reduction, instead of reactively caching data to identify repetition, at byte/bit level or object level. Another notable feature of some embodiments is building the stored index of attribute fields, so that the values of the indexed values (also called indices) includes information about the part of the network being monitored, such as for example the topological relations between the indexed attribute values, and carrying out complex event processing (group based analysis or clustering analysis).

Here topological relation (or topological knowledge) refers to the layout of the connections (or relations) between the items the attributes are representing (for example the items being cells if the attribute is cell ID). It may be physical, such as geo distance between cells, or logical, such as pre-defined cell groups or logical distance between cells (i.e. neighboring relations between cells).

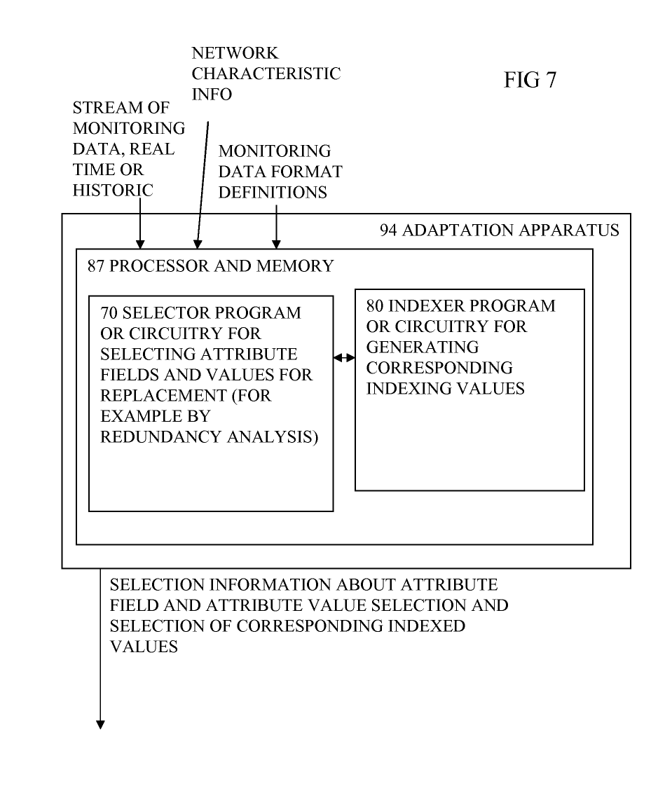

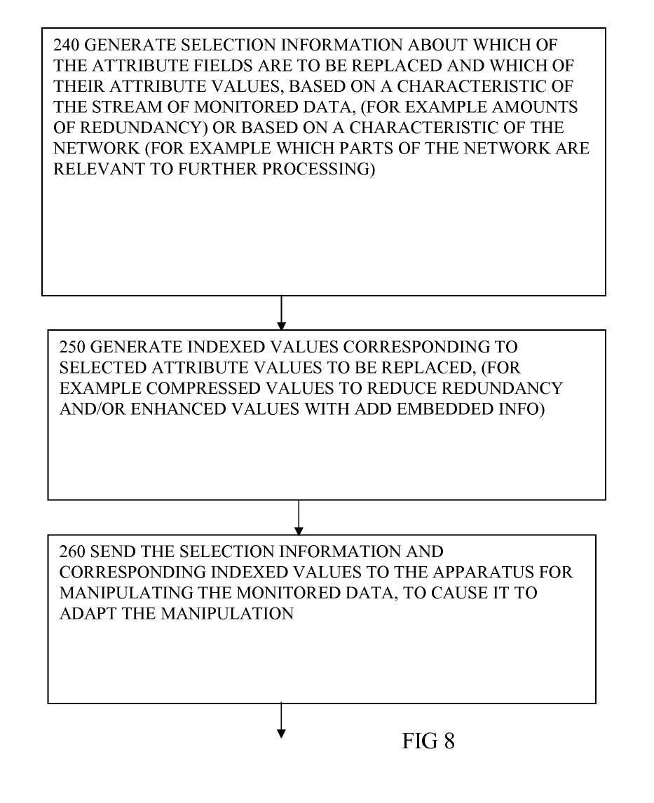

### FIGS. 7, 8, 9 and 10, Embodiments Relating to Adapting the Selective Replacement

FIG. 7 shows a schematic view of an embodiment of apparatus for adaptation of the manipulation of the monitoring data. The apparatus comprises a processor and memory 87 which are arranged to generate selection information about attribute field and attribute value selection, and about selection of corresponding indexed values for adapting the stored index. These are output to the apparatus for manipulating the stream, to cause it to adapt its selective replacement. The processor and memory receive inputs in the form of a stream of monitoring data, real time or historic, network characteristic information and definitions of the monitoring data format. A selector program 70 (which can be implemented as circuitry rather than a program) is configured to generate the selection information for selecting the attribute fields and attribute values for example based on redundancy analysis in the case of data compression. An indexer program (again implementable as circuitry) is configured to generate the corresponding indexing values for building the stored index.

The selector program can incorporate a redundancy analyser program coupled to receive information such as streams of monitoring data, real time or historic, so as to observe frequencies of occurrence of attribute values. It can also receive the definitions of data format of the monitoring data, and the network configuration information, if this is useful to establish limits on numbers of unique attribute values for example.

The redundancy analyser program can be configured to determine which attribute fields have most amounts of redundancy by calculating how many indexed values are needed, thus how much shorter they can be than the attribute values, and how frequently they occur, so that the best selection can be made of which attribute values to replace, to maximise the bandwidth reduction. Amounts of redundancy or similar indications can be output to the indexing program 80 which can select which attribute values to replace and what indexed values to choose to replace them. These selections can be stored in the index as a mapping so that the looking up part described earlier can use the stored index to obtain the indexed values. For attribute values not selected, the stored index can return a null for example, or this information can be stored separately by the looking up part. Various ways of implementing this can be envisaged.

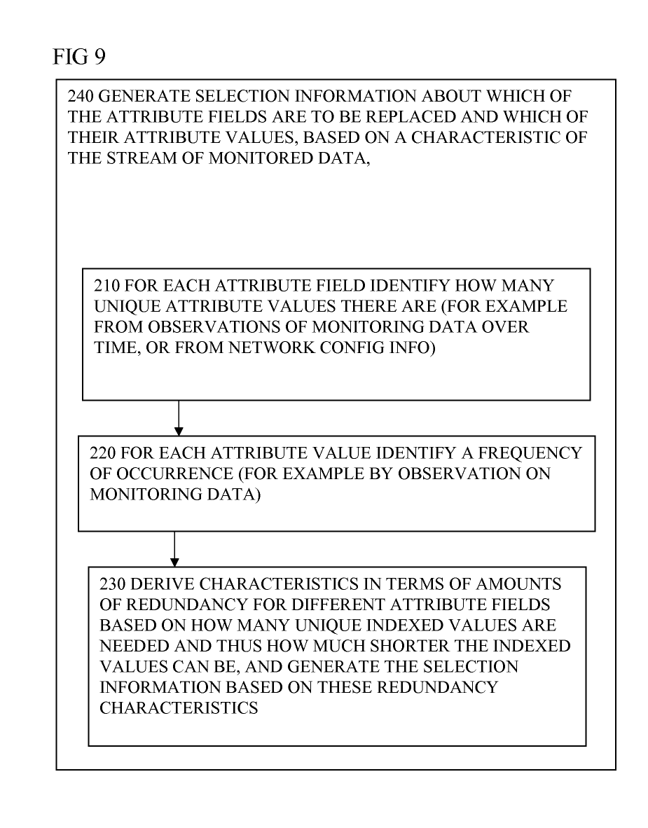

FIG. 8 shows steps in operation of the apparatus of FIG. 7, for a method of adapting the manipulation of the monitoring data. Step 240 shows generating selection information about which of the attribute fields are to be replaced and which of their attribute values, based on a characteristic of the stream of monitored data, (for example amounts of redundancy) or based on a characteristic of the network (for example which parts of the network are relevant to further processing). Step 250 shows generating indexed values corresponding to selected attribute values to be replaced, (for example compressed values to reduce redundancy and/or enhanced values with add embedded info). The selection information and corresponding indexed values are sent to the apparatus for manipulating the monitored data, to cause it to adapt the manipulation, at step 260. This can involve updating the stored index, and in some cases changing the look up circuitry and/or the replacement circuitry if the selection is implemented in these parts.

FIG. 9 shows steps involved in an implementation of step 240 specific to data compression. At step 210, for each attribute field the redundancy analyser identifies how many unique attribute values there are. This can be done based on definitions of the attribute field, based on limitations derived from the existing network configuration, or based on observations of streams of monitoring data over a period of time for example. The configuration information about the network can include for example topology, or geographical location, or membership of a cluster, or the part being on a particular path for example. At step 220, for each attribute value, a frequency of occurrence is obtained, for example by observation of monitoring data.

At step 230, characteristics such as amounts of redundancy are derived for different attribute fields based on how many unique indexed values are needed and thus how much shorter the indexed values can be, as well as from the frequency of occurrence of the different values.

FIG. 10 shows an embodiment similar to that of FIG. 8, but specific to embedded information. The step 250 is implemented by step 252 of generating indexed values having embedded information concerning the part of the network and relationships with other parts, such as topology such as identity of cluster, for further processing such as correlation of monitoring data from related parts. Such embedded information can be useful to enable later processing of indexed values to be made more efficient since there is no longer a need to look up such information from elsewhere.

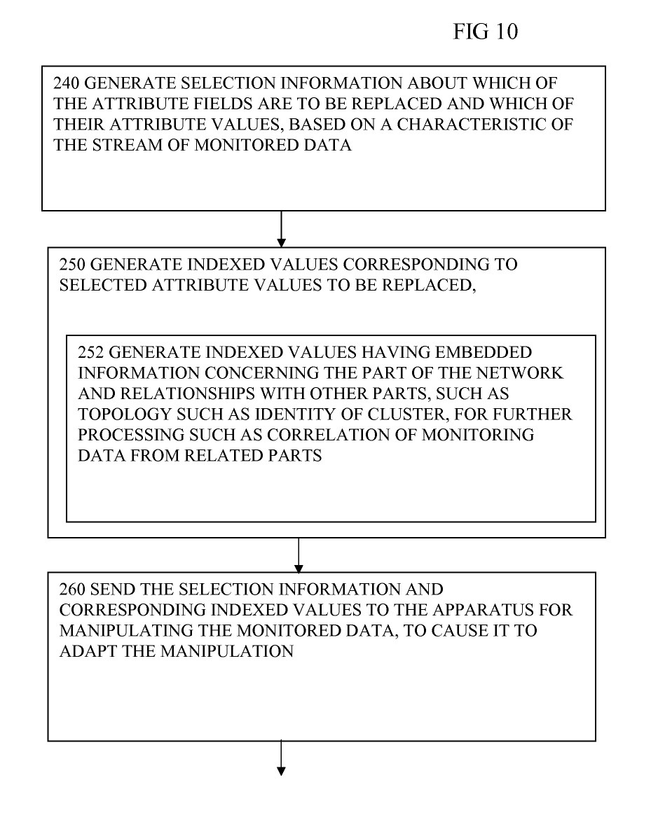

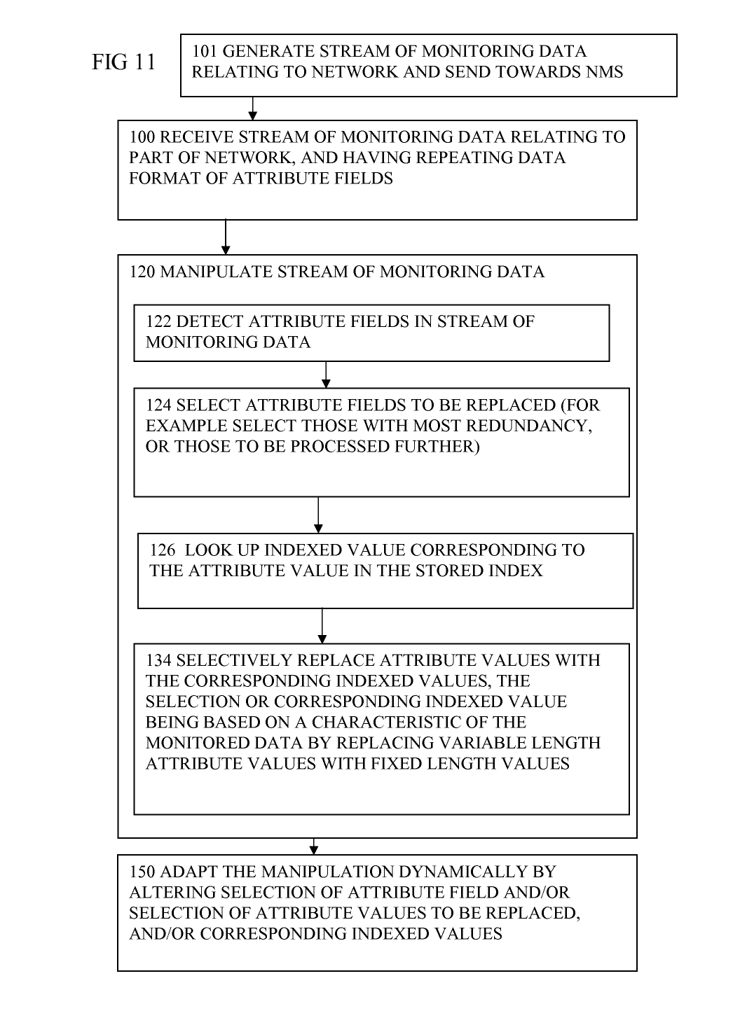

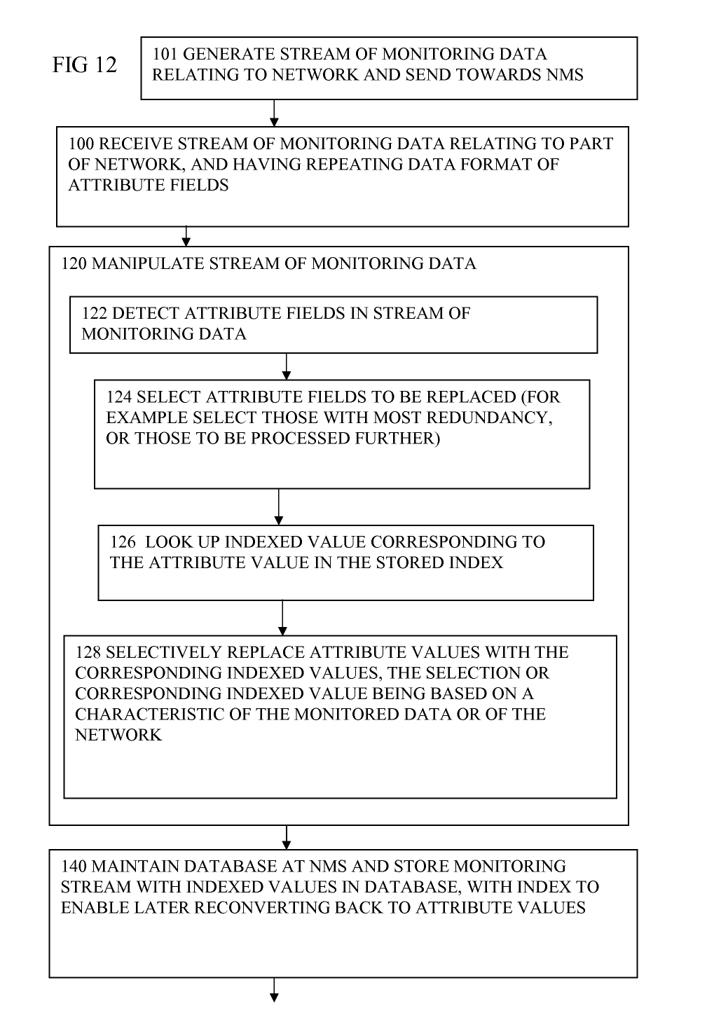

### FIGS. 11, 12 Embodiments Having Further Features

FIG. 11 shows an embodiment similar to FIG. 2 and showing further features as follows, each of which can be implemented separately without the others. A preliminary step 101 of generating the stream of monitoring data and sending it towards the NMS is shown. The following steps of manipulating the monitored data can be carried out anywhere on the path to the NMS or on receipt at the NMS. After step 124, the replacement step is step 134 in which selected attribute values are replaced by corresponding indexed values, and where the selection or corresponding indexed value is based on a characteristic of the monitored data by replacing variable length attribute values with fixed length values. This can enable further processing of such indexed values to be carried out more efficiently.

A further step 150 is shown of dynamically adapting the manipulation by altering in use the selection of attribute field and/or the selection of attribute values and/or the choice of corresponding indexed values. This can be done as a preliminary step or carried out at any time, if conditions change or if the network configuration changes.

FIG. 12 shows an embodiment similar to FIG. 2 and showing further features as follows, each of which can be implemented separately without the others. A preliminary step 101 of generating the stream of monitoring data and sending it towards the NMS is shown. After the manipulating of the monitoring data at step 140, the monitoring stream is received at the NMS where a database is maintained. The monitoring stream is stored in the database without reconverting the indexed values back to their original attribute values. If a copy of the stored index is kept with the stored version of the monitoring data, then the original attribute fields can be recovered later more easily. This feature is not dependent on how the selective replacement is carried out nor where it is carried out.

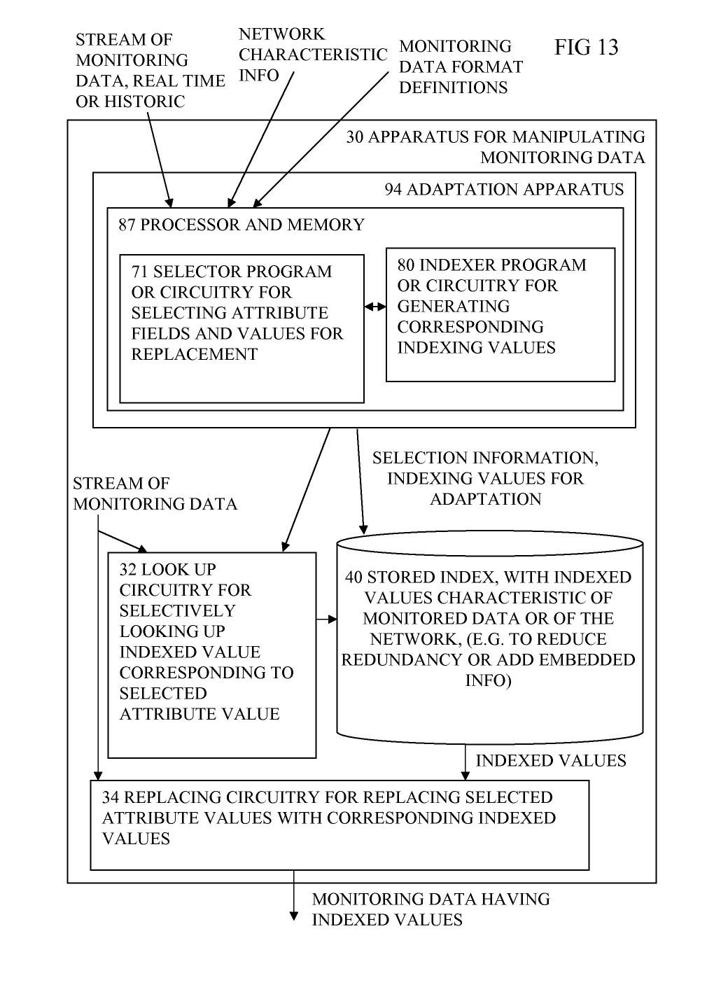

FIG. 13, Embodiment Having Apparatus for Adaptation with the Apparatus for Manipulation

FIG. 13 shows an embodiment having the adaptation apparatus 94 as shown in FIG. 7, incorporated in the apparatus for manipulating the monitoring data, as shown in FIG. 1. These parts need not be co-located. The selection information generated by the adaptation apparatus can be fed to the look up circuitry and/or to the replacing circuitry and/or to the stored index, according to where the selection for the selective replacement is implemented. The generated corresponding indexed values are fed to the stored index. The adaptation apparatus can be located at a centralised location which may be near the NMS (not shown) or incorporated in the NMS. These parts can adapt and therefore build the index as described above in relation to FIGS. 7 to 10. The stored index 40 can be located at a remote location, which may be at the part of the network being monitored, or in any location in between that part and the NMS. By having the index build parts centralised near the NMS they can be controlled more easily by the NMS, or may make use of processing resources of the NMS for example. By having the stored index at the remote location, the compressing of the monitoring data can be carried out before transmission to the NMS thus saving transmission resources.

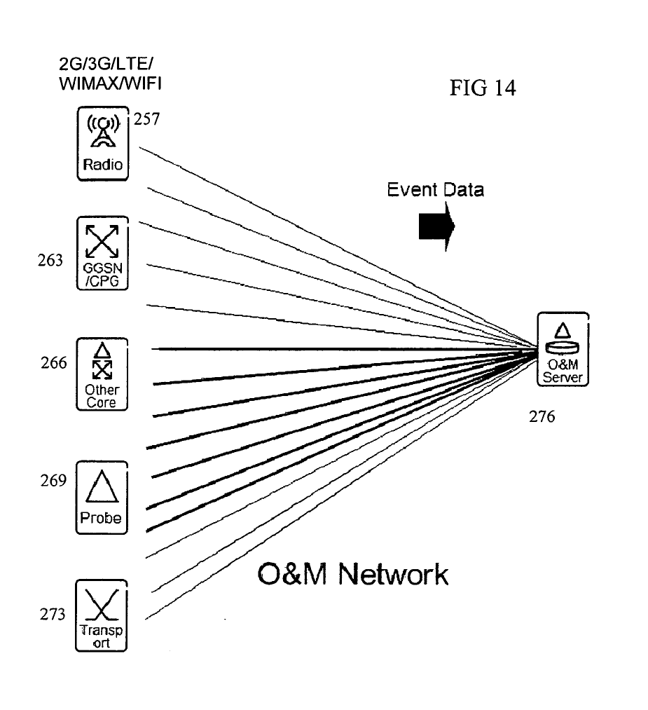

### FIG. 14, O and M Network Example for Transmitting Event Data

FIG. 14 shows in schematic form an example of an O and M network for sending streams of monitoring data in the form of event data. Embodiments can be applied to this as will be explained. Parts of the network being monitored include a radio network 257, a gateway GPRS support node 263, other core network nodes 266, a probe 269, transport network nodes 273. Some or all of these feed event data to the O and M server which is part of an NMS.

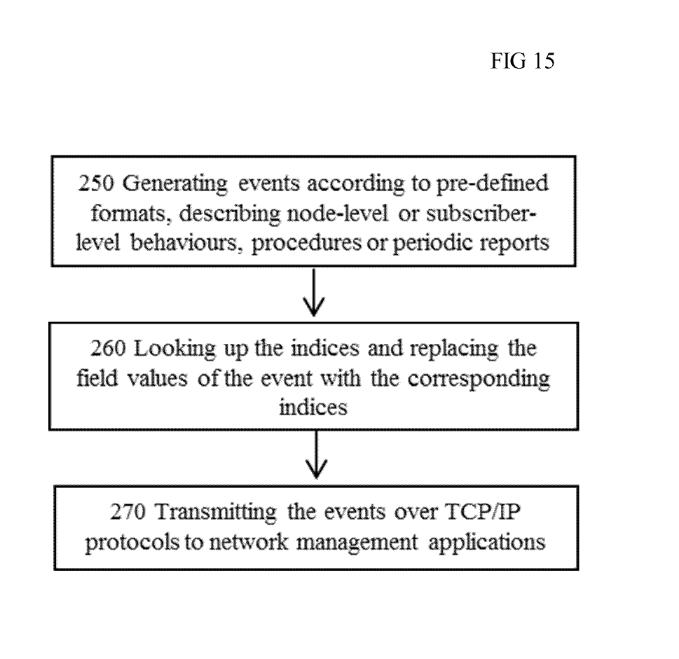

### FIG. 15, Event Based Embodiment

FIG. 15 shows steps according to an embodiment including generating at step 250 a stream of monitoring data in the form of events according to pre-defined formats, describing node-level or subscriber level behaviours, procedures or periodic reports. At step 260 there is a step of looking up the indexed values (indices) and replacing the attribute values of the attribute fields with corresponding indices.

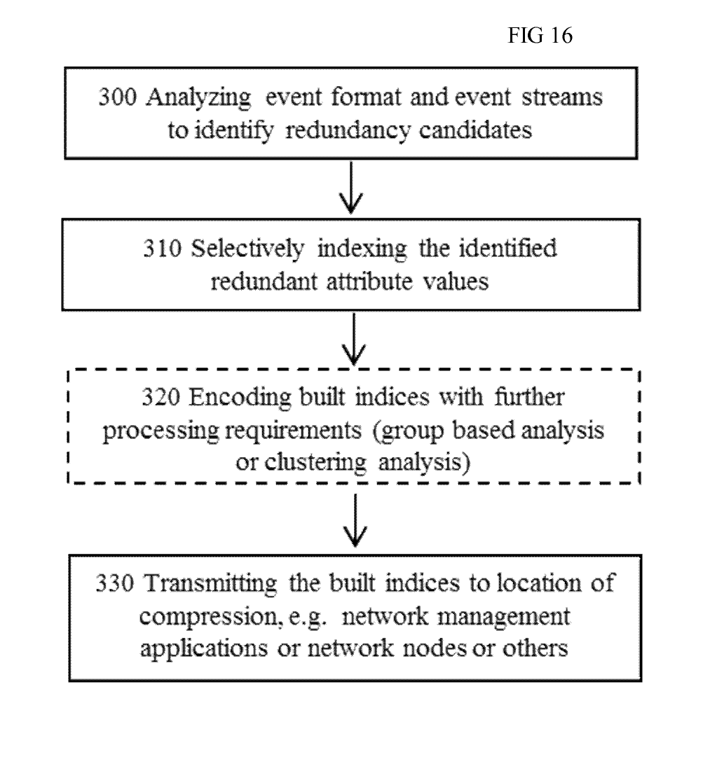

### FIG. 16, Building Index

FIG. 16 shows a method for building the index for use in the method of FIG. 13. There is a step 300 of analysing event format and event streams to identify redundancy candidates, then a step 310 of selectively indexing the identified redundant attribute values. An optional step is shown in dotted lines, of further encoding or supplementing the built indices with information for assisting further processing, such as group based analysis or clustering analysis. At step 330, the built indices are transmitted to the location of the transmission, for example network management applications or network nodes or others.

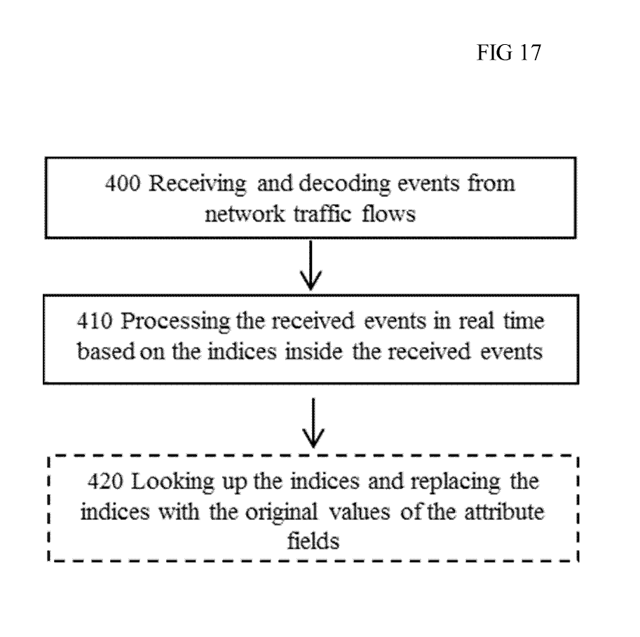

### FIG. 17, Real Time Processing

FIG. 17 shows method steps involving using the monitoring stream after replacement of some of the attribute values to compress the data. These steps could be taking place at the O and M server 276 of FIG. 12 for example. At step 400 the events are received and decoded from network traffic flows. At step 410 processing of the received events in real time is carried out based on the indices inside the received events. Such processing could be for example correlation of fault indications to locate a source of a cascade of faults. At step 420 there is an optional step in a dotted line box of looking up the index to find the original attribute values and replacing the indices with their original attribute values before the event is stored or processed further.

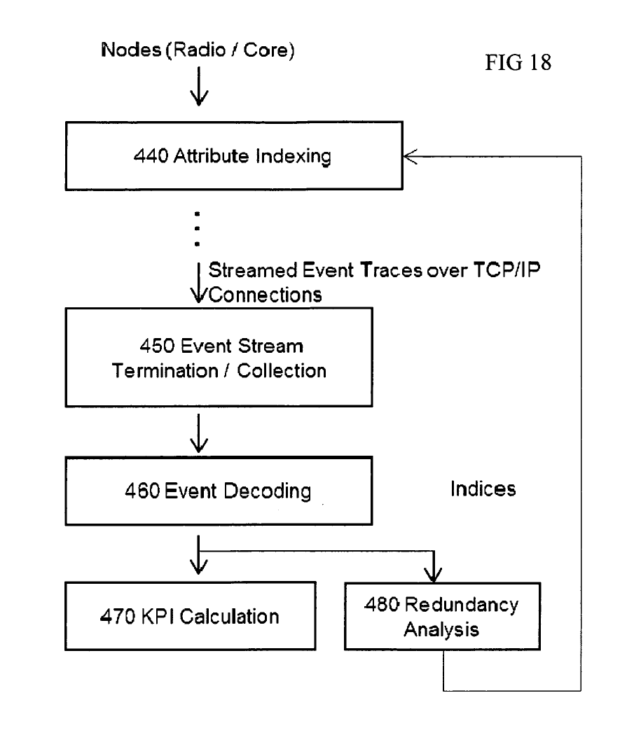

FIG. 18 Method with Compression and Adaptation of Indices

FIG. 18 shows steps in monitoring with compression of monitoring data according to an index and adaptation of the index. At step 440 monitoring data is fed from nodes such as those for a radio network and a core network and compressed by selective replacement according to an index. The streams of event traces with data compression are sent over TCP/IP connections to an NMS where at step 450 there is termination and collection of event streams. At step 460 the events are decoded to enable individual attributes to be distinguished and processed. An example of such processing is a KPI calculation 470. At the same time, the decoded events are analysed at step 480 for redundancy, to see if the index can be optimised. If so the index is revised and the revised index is fed back for use in step 440.

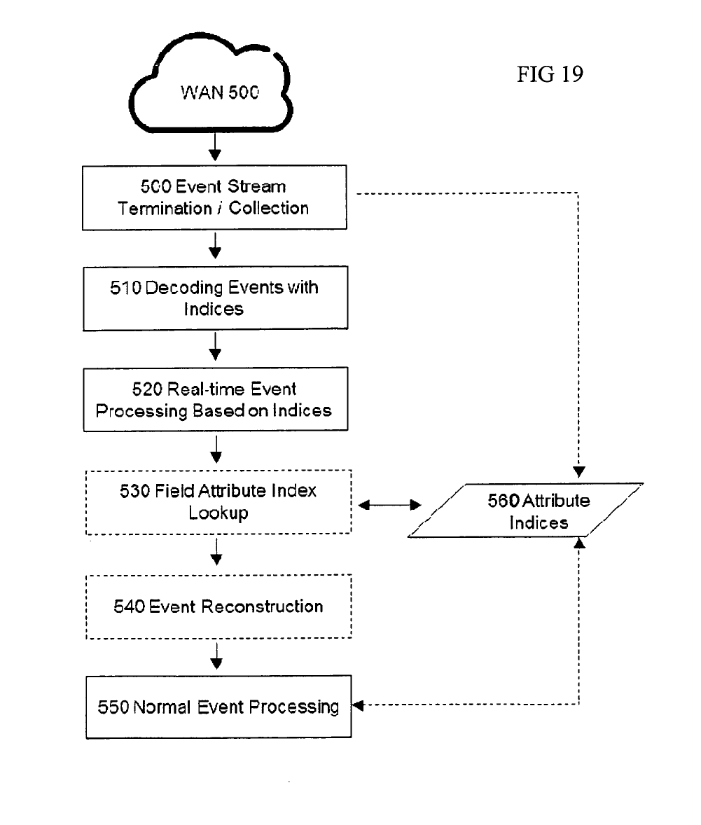

FIG. 19, Embodiment with Real Time Processing

FIG. 19 shows receiving a stream of events over a WAN and terminating/collecting the stream at step 500, then decoding the events with indices at step 510. Real time event processing based on the indices takes place at step 520. Optional steps in dotted line boxes are for decompressing the data as shown at steps 530 for looking up the original attribute values and reconstructing the event by replacing the indexed values with the original attribute values at step 540. Then normal event processing can take place at step 550. The look up step uses the attribute indices 560 which can be transmitted with the event stream, and can be adapted or used by the normal event processing step.

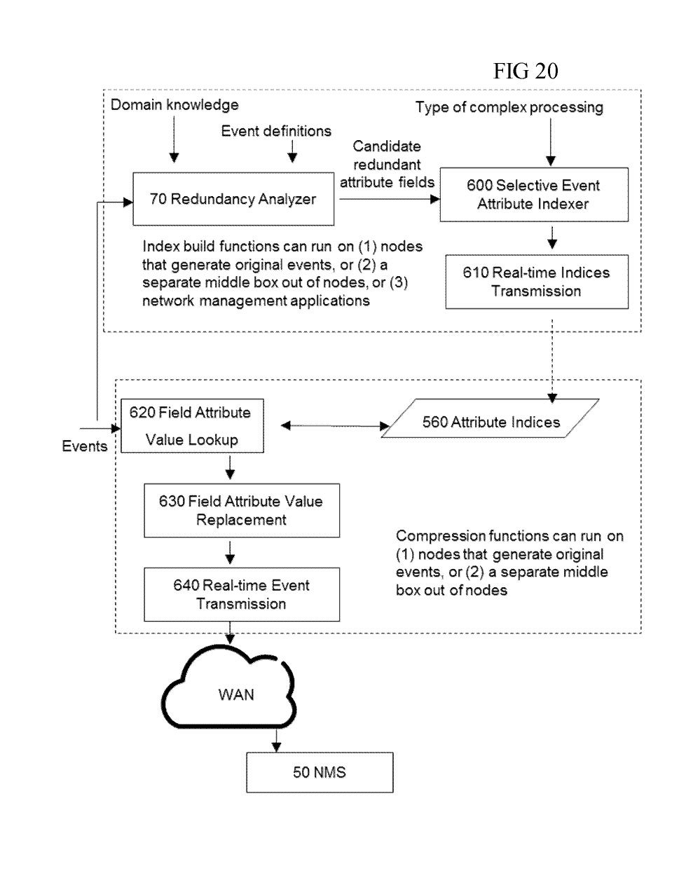

FIG. 20, Embodiment with Compression and Index Build Functions

FIG. 20 shows index build functions such as redundancy analysing by analyser 70, feeding a selective event attribute indexer 600. The resulting index is sent on by real time indices transmission 610 to build the attribute indices 560. The compression functions include a field attribute value lookup 620, which uses the attribute indices 560 and feeds the field attribute value replacement function 630. There is a real time event transmission part 640 which transmits the compressed event stream over the WAN to an NMS 50. The index build functions can run on nodes that generate original events, or on separate intermediate boxes external to such nodes, or on network management applications. The compression functions can run on nodes that generate original events or on a separate middle box away from the nodes.

The following sections give further details of the key parts or algorithms. Note that there are multiple implementation options. The following sections are based on the option that redundancy analysis and selective indexing run on network management applications, while indices based streaming runs on network nodes. Later sections give details of other implementation options.

### Redundancy Analysis

Redundancy analysis over real-time event transmissions focuses on duplicate values of attributes across multiple events. The proposed analysis can exploit the localization of data carried by events, which is achieved based on knowledge on event formats, local network configurations, and event data that is initiated locally. As mentioned earlier, redundancy analysis can run on network management application as one possible implementation.

The proposed analysis is not limited to events or to monitoring data from any particular type of source. It is applicable to monitoring data such as events from multiple sources and can analyze redundancies across multiple event streams of different types.

### Event Format Analysis

Event format of a particular source is pre-defined in XML files based on scheme files. In the format, at least the following information is included: Name and identifier of an event; Attribute/parameter definitions of an event, including name and size of each attribute;

One example event is defined as follows.

<event>

<name>BEARER_UPDATE</name>
<id>5</id>
<triggerdescription></triggerdescription>
<comment>Provides information when the bearers are
updated.</comment>
<elements>

<struct type = “HEADER”>HEADER</struct>
<param type =
“CAUSE_PROTOCOL”>CAUSE_PROTOCOL</param>
<param type = “CAUSE_CODE”>CAUSE_CODE</param>
<param type =
“SUB_CAUSE_CODE”>SUB_CAUSE_CODE</param>
<param type =
“EVENT_TRIGGER”>EVENT_TRlGGER</param>
<param type =
“ORIGINATING_NODE”>ORIGINATING_NODE</param>
<struct type = “PDN_INFO”>PDN_INFO</struct>
<struct type = “UE_INFO”>UE_INFO</struct>
<struct seqmaxlen = “11” type =
“BEARER_INFO_QOS”>BEARERS</struct>
<struct type =
“IPADDRESS_STRUCT”>MME_OR_SGSN</struct>

</elements>

</event>

Attributes of an event and size of each attribute are extracted from the definitions.

### Cardinality Analysis on Attribute Values

This is to calculate number of unique values (i.e. cardinality) of an attribute in an event, to estimate the required indices length. There are three types of cardinalities in the context of this:

Cardinality by definition: the number of possible unique values of an attribute, limited by size of the attribute, may be defined in the event format, such as enum data type. Such information shall be extracted from event format definitions.

Cardinality by configuration: it is common that only a small subset of available values is used in a network instance. Cardinality by configuration refers to the number of unique values of an attribute that are possible in local configuration. Such information shall be extracted from network configurations, such as network topology repositories.

Cardinality by observation: it is highly possible that not all of the attribute values are relevant to the event streams (the redundancy of which is being studied). This is to calculate number of unique values that have been observed over the studied event streams during a pre-defined time window (for example 24 hours. or 7 days, by default). In the proposed best-mode implementation (mentioned earlier), this cardinality can be calculated by storing the events in a data warehouse for the pre-defined period and then using DB functions in cardinality calculation.

### Frequency Analysis on Attribute Values

This is to further count occurrence frequency of attribute values over the studied event streams during a pre-defined time window (24 hours, or 7 days, by default). The aim is to further reduce the required indices length by only considering most frequent values in the indexing. In one proposed implementation (mentioned earlier), this frequency analysis can be done by storing the events in a data warehouse for the predefined period and then using ranking functions in DB aggregation functions to get the most frequent items of an attribute field.

It is estimated that the popularity of each attribute value follows a zip-f style distribution (http://en.wikipedia.org/wiki/Zipfslaw), i.e. the frequency of any attribute is inversely proportional to its rank in the frequency table. By focusing on only frequent items, the indices length is minimized, which significantly reduces the overhead introduced by the proposed solution.

Note that frequency analysis may be applied to attribute values with large size (for example>4 bytes) to maximize the gains in resource savings. After these three steps, a redundancy table can be constructed for further analysis, having columns, in this example, for attribute name, attribute size in bits, number of unique values defined, number of unique values limited by network configuration, number of unique values observed, list of top-K frequent values, and frequency of Top K frequent values.

Note that redundancy analysis may be implemented in different ways: offline analysis, on-the-fly analysis or a hybrid approach. If the redundancy is analyzed based on event format (for attribute size) and network configurations (for number of configurable unique values), the redundancy analysis can be done immediately by importing event format definitions and topology into the redundancy analysis engine.

If the redundancy is analyzed based on event traffic observations (for observed number of unique values and top-k frequent values), the redundancy analysis requires a per-defined observation period before indices can be built. Moreover, the built indices are subject to on-the-fly changes if the frequency is observed periodically, i.e. every observation window.

### Building Indices

This is to build indices on attribute fields of an event for the following two purposes:
Selectively based on identified redundancy, to reduce overhead in event transmission (i.e. bandwidth savings) and event processing (i.e. CPU & memory savings);
Facilitating real-time processing by incorporating topological relations between items into the index.

In particular, the algorithm is to select attribute values to be indexed and then determine the index for each attribute value based on their topological relations (such as groups for group analysis and distances for clustering analysis). Note that indexing for real-time processing can be implemented separately from indexing for redundancy elimination.

The output of this algorithm is an index table of values for selected event attributes. In one implementation (as mentioned earlier), a network management application is responsible for redundancy analysis and then further building the indices. The generated indices table shall be distributed by network management application towards network nodes, which uses the indices table in event generation.

The index doesn't have to have a one-to-one mapping. One attribute value should be mapped onto only one index value; however, there might be multiple attribute values that are mapped onto the same index value. For example, one SGSN node may have multiple SGSN IP addresses. It is possible that all SGSN IP addresses of the same SGSN node are mapped onto the same index value; however, when looking up a particular SGSN IP address, there should be only one index value (to keep the integrity of the data).

### Selectively Indexing

This can help to maximize the gains (i.e. resource saving) and minimize the overheads of introducing indices into event transmission and processing. The idealistic attribute values to be indexed if compression is the aim are those with:
Large size, which means such attributes may consume large amount of resources in transmission and processing; and
Very low cardinality (configured or observed), which means building indices on such attributes requires few bits; and
Values with high frequency, which means the saving is maximized by indexing such attribute values.

Accordingly, based on the candidate redundancy table calculated previously, one implementation of the selection algorithm is as follows:
Filtering attribute fields with size smaller than 4 bytes (32 bits);
Estimating required length of index for each attribute field; if based on top-K frequent values only, the required index length shall be log 2 (K);
Calculating the resource savings for each attribute field in the candidate redundancy table, using the following equations: (attribute_sizeindex_length)*frequency;
Selecting the attributes with the maximum resource savings.

Note that this is only one of various possible implementations. The observed cardinality, or the configured cardinality, may be used to calculate the required length of index, instead of using top-K attribute values. One reason for this is that finding top-K attribute values may consume considerable resources.

In one example the following fields can be considered for indexing:
APN (Access Point Name), composed of APN Network Identifier and Operator Identifiers, with a maximum length of 100 octets, while a typical large operational network may configure around 1000 APNs (which can be indexed with 10 bits);
IP addresses especially core nodes (32 bits for IPv4 and 128 bits for IPv6). An OSS instance may work with at most 20 GGSNs and 40 SGSNs, which requires at most 6 bits; also IP addresses appear frequently in most events;
URI, typical length estimated to 800 bits (i.e. 100 bytes);
IMEI & IMEISV (International Mobile Equipment Identity Software Version), 64 bits;
IMSI (International Mobile Subscriber Identity, 64 bits) and MSISDN (Mobile Subscriber Integrated Services Digital Network Number, 72 bits), preferably on top-K subscribers only;
Cell IDs, preferably on top-K busiest cells only;
   3GPP TS 23.003 gives detailed definitions for such attributes.

It is clear that not all of the values of an attribute may be indexed (i.e. partial indexing). So an extra bit may be required as indexing flag, to differentiate indexed values from original values of the attribute.

### Indexing for Real-Time Event Stream Processing

This is to use indexed attribute values to facilitate real-time event processing. Originally, each attribute field is encoded with values as they are given. In order to carry out real-time analysis on event attributes such as group based on analysis on nodes (based on node IP addresses or node IDs), terminal types (based on IMEISV), URIs and APNs, a list of group membership shall be maintained and looked up for each event to be processed. With extremely high aggregate event rate, this may consume significant system resources.

It is proposed to build index values for the attributes that are to be processed in real time by the network management applications. In particular, the built index can reflect the topological relations between the attribute values. Note that the detailed indexing scheme depends upon the operations of the complex event processing. At least the following indexing options can be considered:

### (1) Building Indices for Group Based Analysis

This is to add group IDs as part of the index, prepared for further group based analysis. The group IDs may be hierarchically organized with sub group IDs. The group IDs shall be pre-defined based on group definitions (such as terminal groups based on handset terminal types, subscriber groups based on IMSIs, SGSN groups, APN groups and URI groups). The groups are usually manually defined at the network management applications. Examples of a format of an indexed value having additional information are shown in tables 1 and 2 below:

TABLE 1

| | |
|---|---|
| Group ID | Rest of the index |

TABLE 2

| | | |
|---|---|---|
| Group ID | Sub Group ID | Rest of the index |

(2) Hierarchical Indexing with Topological Proximity or Other Logical Proximity

This is to index attribute values such as node IP addresses to reflect logical or topological proximity between nodes, to facilitate possible clustering based analysis. One example is a tree structure having a single top level node, three middle level nodes (1, 2, 3) and five lower level nodes. A first of these is labelled 1-1-1, as it is linked to the first of the middle level nodes. The next three lower level nodes are linked to the second of the middle level nodes and so can be labelled 1-2-2, 1-2-3, and 1-2-4. The fifth lower level node in this example is linked to the third of the middle level nodes and so can be labelled 1-3-5.

In a simplified network, the cell IDs at the bottom of the topology can be indexed hierarchically so that the values of the indices reflect neighboring relations between cells. Further clustering based analysis can be applied based on such logical proximities, to cluster cells and pinpoint root causes of failures.

For example, if events associate with 1-2-2, 1-2-3 and 1-2-4 report handover failures, it can be preliminarily inferred that node 1-2 can possibly be the cause. Without such enriched indexed values, the network management applications would have to map events onto network topologies before carrying out clustering, since cell IDs carry no information about network topology. This is not feasible or at least expensive to implement in the presence of high event rates.

(3) Building Indices with Geographical Proximity

This is to index attribute values such as node IDs with geographical information (such as cell geo location), so that the index reflects geographical distances, for example, between cells. The corresponding clustering analysis can be further carried out based on the geo information within the index. Note that the attribute values may be indexed in on-demand way and therefore dynamic. In case that group based (complex) real-time event processing is enabled, the index may be built to incorporate group IDs. After a pre-defined time period, the indices shall be invalidated. New indices might be built for the same attribute values for the purpose of different types of realtime event calculations. A validation time window may be associated with such index. The index may get invalid after the pre-defined time period and therefore removed from the indices table.

### Real-Time Stream Processing Using Indices

As mentioned earlier, complex event processing such as group based analysis and cluster analysis gets much simpler using indices, since the indices already contain information about groups and distances between indexed items. No lookup or correlation operations are required. The corresponding counters can be configured to calculate corresponding performance indicators in real time.

### Other Variations in Implementations

The proposed solutions may be implemented in several different ways:

(1) Plug-in based implementation: the redundancy analysis (and replacement of attribute values with indices) can be implemented as plug-ins of the encoding process of the events. Before events are written into binary blocks, the original values of each attribute are examined by the redundancy analyzer and replaced with indices if the indices exist in the indices table.
(2) Middle-box implementation: alternatively, some or all of the proposed operations can be done in a separate middle box. This may introduce extra cost but with little impact on existing systems.
(3) Sender initiated redundancy elimination: the proposed solution in previous sections assumes that the network management applications carry out redundancy analysis and build indices. Alternatively, these operations may be carried out by event senders, i.e. network nodes. The generated indices need to be sent to the network management applications. Indices from different nodes may be merged.
(4) Event re-construction: the proposed solution doesn't require events to be re-constructed at the receiver side. That is, the receiver may keep the received events at they are, without replacing the indices back with original values. This may further reduce the size of the storage required for the same amount of events, since the indices are much smaller in length than the original values. Accordingly, SQL queries need to be looked up in the indices table before executed onto the stored events.
(5) Hardware implementation of event processing based on indices: a hardware based processing solution is particularly suitable because of the following benefits: Firstly, indices can be used to remove differences between lengths of attribute values; that is, all attribute values of a field or of an event can have equal lengths. This can reduce the complexity of using CAM or TCAM (http://en.wikipedia.org/wiki/Content-addressable_memory) in event processing.

Secondly, indices contain all required information for the analysis. There is no need to carry out further memory accesses and searches for such correlation operations.

### Summary of Some Embodiments

As has been described, some embodiments use a method, algorithms and functions for event based real-time monitoring of large-scale operational networks and services by selectively building indices for attribute fields of an event to (1) eliminate redundancy in event transmission and processing and (2) facilitate real-time event processing. This can involve a method of event based real-time monitoring of large-scale operational networks and services, comprising: —analyzing size, number of unique values of an attribute field, and frequency of each value of an attribute field inside an event, to identify candidates for redundancy elimination; selectively indexing the identified redundancy attribute values; transmitting the built indexes to network management applications; generating an event recording/describing node-level or subscriber level behaviors, procedures or periodic reports, according to predefined formats; replacing the identified field values of the event with the corresponding indices and transmitting the event (for example over TCP/IP protocols) to network management applications; and processing the events in real-time based on the indices inside the received events.

Other embodiments involve methods of eliminating redundancy in event transmission from a plurality of nodes to network management applications in a large-scale operational network, by: identifying redundancy across multiple events in a event stream by analyzing event format definitions, number of unique values of an attribute field inside an event and frequency of each values of an attribute field; building indices selectively for the identified attribute fields and transmitting the indices to network management applications; replacing the identified field values of the event with the corresponding indices and transmitting the event (for example over TCP/IP protocols) to network management applications.

A third group of embodiments have steps of analyzing redundancy for real-time transmissions in event based monitoring, by: analyzing event formats from different sources/nodes and extracting attributes, unique values (if available) and size of each attribute; calculating number of unique values for each attribute field extracted based on local domain knowledge, including network topologies and configurations; identifying most frequent values of each attribute field extracted by periodically sampling events in the real-time transmissions; and identifying candidate redundant attribute fields using calculated results from previous steps.

A fourth group of embodiments has methods of real-time complex event processing based on indices of attribute fields of an event, by: building indices for an attribute field, with topological relations between indexed items; replacing values of attribute fields of an event with the built indices and transmitting the events over TCP/IP protocols to network management applications; and processing the events using indices instead of original values, using topological relations between indexed items for real-time processing.

A fifth group of embodiments involves methods of selectively building indices for attribute fields of an event to eliminate redundancy, by calculating possible unique values of an attribute field of an event based on network topology and network configurations; counting number of unique values of the attribute field of an event that are observed in event streams during a pre-defined time period; calculating frequencies of occurrence of each value of the attribute field of an event to identify most frequent values of an attribute file during a pre-defined time period; estimating length of an index required for the most frequent attribute values of the attribute field; calculating bandwidth savings by subtracting the index length from the size and then multiplying frequency of the attribute field; and building indices for the attribute field if the bandwidth savings is above a pre-defined threshold.

A sixth group of embodiments involves methods of event based network and service monitoring of a large-scale operational network by selecting attribute fields and building indices for selected attribute fields based on redundancy observations on pre-defined network segments within a pre-defined time period. (This shows dynamically building indices based on temporal/spatial observations of redundancy.)

A seventh group of embodiments has methods of event based network and service monitoring of a large-scale operational network by: inputting the type of aggregation calculations of the event processing engine (clustering or group analysis); building indices based on the type of aggregation calculations and topological knowledge of indexed attribute fields, so that the values of the indices reflects the topological relations of the attribute fields; and transmitting and processing events with indices until further instructions on the type of aggregation calculations are received. (This shows dynamically building indices on demand, based on the types of the processing to be carried out by network management applications; and changing indices or adding indices if a different type of processing is expected.)

Various of the embodiments have some or all of these following benefits over existing solutions for compressing streams of monitoring data such as event based streams:

(1) Facilitated real-time complex eventstream processing by indexing attribute fields based on processing requirements. By implementing the solution using hardware such as CAM, the performance can easily reach multiple millions of event rate per second (based on mature DPI performance; a 10 Gbps throughput DPI solution with average packet rate of 500 bytes).
(2) Reduced transmission overhead: The proposed redundancy elimination solution combines knowledge on events (i.e. event formats), domain knowledge (in determining number of unique values of an attribute field) and frequency of a value of the attribute field in redundancy identification, which maximizes the ratio of redundancy elimination. For example, by building indices on URIs (top 1000 URIs) and APNs (a total of 1000 APNs), the proposed solution could reduce an event of 3431 bits to 456 bits, which leads to 88% overhead reduction.
(3) Reduced event processing overhead: Indices, which can be in binary form, can be decoded and loaded into DB much faster than the original data. In addition, since the values are indexed, any operations on the attribute values, such as type conversion, can be done in the indices table instead of on the attribute of each event.
(4) Improved event processing throughput: Attribute fields of events are featured with variable lengths, which makes hardware based processing difficult. By building indices with equal lengths, it is feasible to use hardware such as TCAM to speed up event processing.
(5) Event independent solution: The proposed solutions are not limited to any specific event types. Redundancy is identified by analyzing event definitions (preferably XML definition files).
(6) Lossless redundancy elimination: Instead of removing duplicated values from events, the attribute fields are re-encoded with indices. No information has been lost during the process.
(7) Compatibility with other redundancy elimination or data compression solutions: The proposed solution operates above event/application layers, which is different from those RE solution running on raw data. Those redundancy elimination or stream compression techniques can be applied side by side with the proposed selective indexing.
(8) There is no need to recover data from redundancy elimination, as compared to RE solutions; original attribute values can be accessed using the stored index.

As has been described above, streams of monitoring data relating to part of a communications network, are manipulated automatically by looking up a corresponding indexed value in a stored index, and selectively replacing that attribute value with the corresponding indexed value. The selective replacement is based on a characteristic of the stream of monitored data, or the network being monitored. The selection or the indexed values can be adapted dynamically. Such selective replacement at the attribute field level can enable the data to be enriched with embedded information or be compressed more efficiently with less processing overhead by exploiting knowledge of the data format and the network configuration. It is compatible with hardware implementations. The embedded information can enable subsequent processing of the monitored data to be speeded up.

Other variations can be envisaged within the scope of the claims.

1. A method of monitoring a part of a communications network, comprising:
receiving a stream of monitoring data relating to the part of the network, the stream of monitoring data having a repeating data format of attribute fields, and
manipulating the stream of monitoring data automatically by:
a) detecting the attribute fields in the stream of monitoring data, and
b) for an attribute value of selected attribute fields, looking up a corresponding indexed value in a stored index, and selectively replacing that attribute value in the data stream with the corresponding indexed value,
wherein the selective replacement is based on a characteristic of at least one of: the stream of monitored data, and the network being monitored.

2. The method of claim 1, wherein the characteristic is redundancy in the stream of monitored data and the selective replacement is based on at least how many unique attribute values there are for the respective attribute field, and on frequencies of occurrence of the different attribute values.

3. The method of claim 1, the step of replacing at least one of the attribute values comprising replacing it with a corresponding indexed value comprising embedded information concerning the part of the network which is generating the monitoring data.

4. The method of claim 3, the embedded information concerning the part of the network comprising information about relationships between the part and other parts of the network.

5. The method of claim 1, comprising the step of processing the monitoring data using the indexed values.

6. The method of claim 4, comprising the step of processing the monitoring data using the indexed values,
wherein the processing step comprises correlating monitored data from related parts of the network using the embedded information about relationships between the part and other parts of the network.

7. The method of claim 1, comprising the step of dynamically adapting how the stream of monitoring data is manipulated in use by altering any of: the selection of attribute field, the selection of attribute values to be replaced, and the corresponding indexed values in the stored index.

8. The method of claim 1, wherein the step of replacing at least one of the attribute values comprises replacing variable length attribute values with corresponding indexed values having a fixed length.

9. A method of adapting manipulation of a stream of monitoring data relating to a part of a communications network, by apparatus having a stored index, the stream of monitoring data having a repeating data format of attribute fields, the manipulating involving replacing selected attribute values with indexed values, the stored index having a mapping of indexed values corresponding to attribute values to be replaced, the method comprising:
generating selection information about which of the attribute fields and which of their values are for replacement, and generating corresponding indexed values, based on a characteristic of at least one of: the stream of monitored data, and the network being monitored, and
sending the selection information and the corresponding indexed values to the apparatus to cause it to adapt its manipulation of the monitoring data according to the selection information and corresponding indexed values.

10. The method of claim 9 comprising:
for each of the attribute fields, identifying how many unique attribute values there are for the respective attribute field, and identifying frequencies of occurrence of the different attribute values, and
deriving characteristics of the stream of monitoring data comprising amounts of redundancy for different ones of the attribute fields, based on the numbers of unique attribute values, and how frequently the different attribute values occur and generating the selection information based on these redundancy characteristics.

11. The method of claim 10, the step of identifying how many unique attribute values there are for the respective attribute field having a step of deriving this from at least one of: configuration information about the network, and observations of monitoring data over a period of time in use.

12. The method of claim 10 wherein the step of identifying a frequency of occurrence comprises the step of observing frequencies of occurrence of the different attribute values in use over a period of time.

13. The method of claim 9, wherein the step of generating indexed values comprises generating an indexed value having embedded information concerning the part of the network which is generating the monitoring data.

14. The method of claim 13, the embedded information concerning the part of the network comprising information about relationships between the part and other parts of the network.

15. An apparatus for manipulating a stream of monitoring data relating to a part of a communications network, the stream of monitoring data having a repeating data format of attribute fields, the apparatus comprising:
a stored index having a mapping of indexed values corresponding to the selected attribute values to be replaced, characteristic of at least one of: the stream of monitored data, and the network being monitored;
look up circuitry, configured to detect the attribute fields in the stream of monitoring data, and for selected attribute fields, to use the attribute values to look up corresponding indexed values in the stored index; and
replacing circuitry configured to selectively replace the attribute values in the data stream with corresponding indexed values according to the stored index.

16. The apparatus of claim 15, having a monitoring data processor configured to carry out real time processing on the monitoring data having the indexed values.

17. The apparatus of claim 15 comprising adaptation apparatus coupled to any of the stored index, the look up circuitry and the replacing circuitry for dynamically altering the manipulating in use by altering any of: the selection of attribute field, the selection of attribute values to be replaced, and the corresponding indexed values in the stored index.

18. The apparatus of claim 17 the adaptation apparatus having a selector configured to determine amounts of redundancy in attribute fields, and to generate selection information for use by the replacing circuitry indicating which of the attribute fields and attribute values should be replaced based on the redundancy amounts, and an indexer configured to selectively create the indexed values for the mapping in the index.

19. An adaptation apparatus for adaptation of a manipulating operation by apparatus having a stored index, to manipulate a stream of monitoring data relating to a part of a communications network, the stream of monitoring data having a repeating data format of attribute fields, the manipulating involving replacing selected attribute values with indexed values, the stored index having a mapping of indexed values corresponding to attribute values to be replaced, the adaptation apparatus comprising:
a processor and memory configured to generate selection information about which of the attribute fields and which of their values are for replacement, and to generate corresponding indexed values, based on a characteristic of at least one of: the stream of monitored data, and the network being monitored; and
an interface for sending the selection information and the corresponding indexed values to the adaptation apparatus to cause it to adapt its manipulation of the monitoring data according to the selection information and corresponding indexed values.

20. A nontransitory computer readable medium comprising instructions which when executed by a processor, cause the processor to carry out a method of monitoring a part of a communications network, the method comprising:
receiving a stream of monitoring data relating to the part of the network, the stream of monitoring data having a repeating data format of attribute fields, and
manipulating the stream of monitoring data automatically by:
a) detecting the attribute fields in the stream of monitoring data, and
b) for an attribute value of selected attribute fields, looking up a corresponding indexed value in a stored index, and selectively replacing that attribute value in the data stream with the corresponding indexed value,
wherein the selective replacement is based on a characteristic of at least one of: the stream of monitored data, and the network being monitored.
